(19) United States
(12) Patent Application Publication
(10) Pub. No.: US 2026/0368944 A1
(43) Pub. Date: Nov. 19, 2026

(54) TriSoup Grid Alignment

(71) Applicant: Comcast Cable Communications, LLC, Philadelphia, PA (US)

(72) Inventor: Sébastien Lasserre, Philadelphia, PA (US)

(21) Appl. No.: 18/637,602

(22) Filed: Apr. 17, 2024

Related U.S. Application Data
(60) Provisional application No. 63/460,005, filed on Apr. 17, 2023.

(51) Int. Cl. G06T 9/40; G06T 9/00; G06T 15/08

(52) U.S. Cl. CPC G06T 9/40; G06T 9/001; G06T 15/08; G06T 2210/12; G06T 2210/56

(57) ABSTRACT

Systems, apparatuses, methods, and computer-readable media are described for determining and/or coding vertex information. Point cloud information, for example, associated with content, may be determined, for example, predicted. A first plurality of cuboids, for example to code a point cloud, may be coded, for example, based on a second plurality of cuboids. The first plurality of cuboids and the second plurality of cuboids may be aligned. The first plurality of cuboids and the second plurality of cuboids may be aligned, for example, to a three-dimensional (3D) grid. The vertex information may be determined and/or coded, for example, based on previously-coded vertex information.

### CROSS-REFERENCE TO RELATED APPLICATIONS

This application claims the benefit of U.S. Provisional Application No. 63/460,005 filed on Apr. 17, 2023. The above referenced application is hereby incorporated by reference in its entirety.

### BACKGROUND

An object or scene may be described using volumetric visual data consisting of a series of points. The points may be stored as a point cloud format that includes a collection of points in three-dimensional space. As point clouds can get quite large in data size, transmitting and processing point cloud data may need a data compression scheme that is specifically designed with respect to the unique characteristics of point cloud data.

### SUMMARY

The following summary presents a simplified summary of certain features. The summary is not an extensive overview and is not intended to identify key or critical elements.

Point cloud information may be predicted (e.g., between frames of content). A first plurality of cuboids (e.g., to code a current point cloud) may, for example, be coded based on a second plurality of cuboids (e.g., a reference point cloud). The first plurality of cuboids and the second plurality of cuboids may be aligned. The first plurality of cuboids and the second plurality of cuboids may be aligned, for example, to a three-dimensional (3D) grid. By aligning the first and second plurality of cuboids, advantages may be achieved such as, for example, improved prediction accuracy and/or reduced bitrates.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example point cloud coding system.

FIG. 2 shows an example Morton order.

FIG. 3 shows an example scanning order.

FIG. 4 shows an example neighborhood of cuboids with already-coded occupancy bits.

FIG. 5 shows an example of a dynamic reduction function DR that may be used in dynamic Optimal Binary Coders with Update on the Fly (OBUF).

FIG. 6 shows an example method for coding occupancy of a cuboid using dynamic OBUF.

FIG. 7 shows an example of an occupied cuboid.

FIG. 8A shows an example cuboid corresponding to a TriSoup node.

FIG. 8B shows an example refinement to the TriSoup model.

FIG. 9A shows an example of voxelization.

FIG. 9B shows an example of voxelization using barycentric coordinates.

FIG. 10A and FIG. 10B show cuboids with volumes that intersect a current TriSoup edge being entropy coded.

FIG. 11A, FIG. 11B, and FIG. 11C show TriSoup edges that may be used to entropy code a current TriSoup edge.

FIG. 12 shows an example encoding method.

FIG. 13 shows an example of coding a centroid residual value.

FIG. 14A, FIG. 14B, and FIG. 14C show examples of a 3D TriSoup method represented in 2D.

FIG. 15A shows an example of a point cloud contained in a bounding box.

FIG. 15B shows example portions of the point cloud of cuboids in the bounding box of FIG. 15A.

FIG. 16 shows an example of TriSoup modeling of a point cloud using 2D representations.

FIG. 17A and FIG. 17B show examples of two successive point clouds encompassed by respective bounding boxes.

FIG. 18A and FIG. 18B show examples of motion compensation between two frames represented in 2D.

FIG. 19A and FIG. 19B show examples of reduced accuracy of inter prediction using motion compensation.

FIG. 20A, FIG. 20B, and FIG. 20C show examples of imposing grid alignment between frames.

FIG. 21A and FIG. 21B show example structures of inter prediction between frames in a sequence of frames.

FIG. 22A, FIG. 22B, FIG. 22C, and FIG. 22D show examples of displacements of bounding boxes between frames.

FIG. 23 shows an example method for TriSoup alignment between point clouds.

FIG. 24 shows an example method for TriSoup alignment between point clouds.

FIG. 25 shows an example computer system in which examples of the present disclosure may be implemented.

FIG. 26 shows example elements of a computing device that may be used to implement any of the various devices described herein.

### DETAILED DESCRIPTION

The accompanying drawings and descriptions provide examples. It is to be understood that the examples shown in the drawings and/or described are non-exclusive, and that features shown and described may be practiced in other examples. Examples are provided for operation of point cloud or point cloud sequence encoding or decoding systems. More particularly, the technology disclosed herein may relate to point cloud compression as used in encoding and/or decoding devices and/or systems.

At least some visual data may describe an object or scene in content and/or media using a series of points. Each point may comprise a position in two dimensions (x and y) and one or more optional attributes like color. Volumetric visual data may add another positional dimension to these visual data. For example, volumetric visual data may describe an object or scene in content and/or media using a series of points that each may comprise a position in three dimensions (x, y, and z) and one or more optional attributes like color, reflectance, time stamp, etc. Volumetric visual data may provide a more immersive way to experience visual data, for example, compared to the at least some visual data. For example, an object or scene described by volumetric visual data may be viewed from any (or multiple) angles, whereas the at least some visual data may generally only be viewed from the angle in which it was captured or rendered. As a format for the representation of visual data (e.g., volumetric visual data, three-dimensional video data, etc.) point clouds are versatile in their capability in representing all types of three-dimensional (3D) objects, scenes, and visual content, Point clouds are well suited for use in various applications including, among others: movie post-production, real-time 3D immersive media or telepresence, extended reality, free viewpoint video, geographical information systems, autonomous driving, 3D mapping, visualization, medicine, multi-view replay, and real-time Light Detection and Ranging (LiDAR) data acquisition.

As explained herein, volumetric visual data may be used in many applications, including extended reality (XR). XR encompasses various types of immersive technologies, including augmented reality (AR), virtual reality (VR), and mixed reality (MR). Sparse volumetric visual data may be used in the automotive industry for the representation of three-dimensional (3D) maps (e.g., cartography) or as input to assisted driving systems. In the case of assisted driving systems, volumetric visual data may be typically input to driving decision algorithms. Volumetric visual data may be used to store valuable objects in digital form. In applications for preserving cultural heritage, a goal may be to keep a representation of objects that may be threatened by natural disasters. For example, statues, vases, and temples may be entirely scanned and stored as volumetric visual data having several billions of samples. This use-case for volumetric visual data may be particularly relevant for valuable objects in locations where earthquakes, tsunamis and typhoons are frequent. Volumetric visual data may take the form of a volumetric frame. The volumetric frame may describe an object or scene captured at a particular time instance. Volumetric visual data may take the form of a sequence of volumetric frames (referred to as a volumetric sequence or volumetric video). The sequence of volumetric frames may describe an object or scene captured at multiple different time instances.

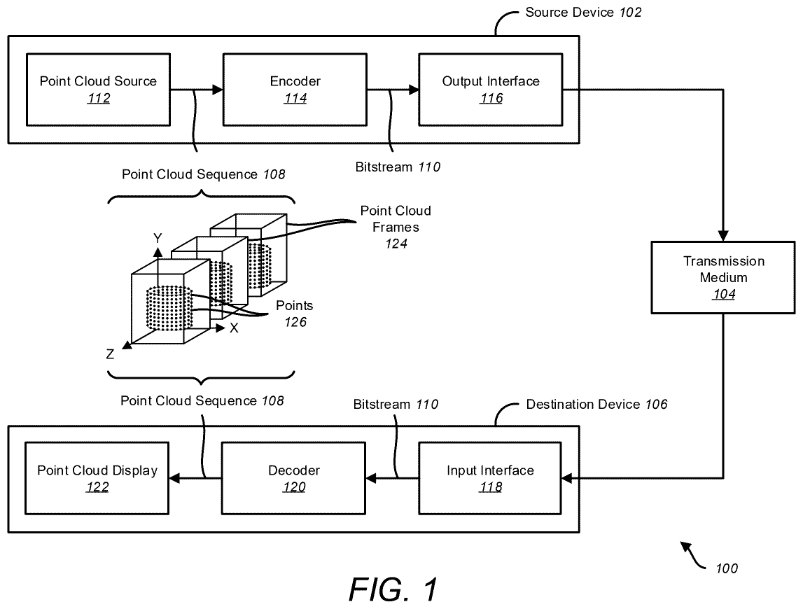

Volumetric visual data may be stored in various formats. A point cloud may comprise a collection of points in a 3D space. Such points may be used create a mesh comprising vertices and polygons, or other forms of visual content. As described herein, point cloud data may take the form of a point cloud frame, which describes an object or scene in content that is captured at a particular time instance. Point cloud data may take the form of a sequence of point cloud frames (e.g., point cloud video). As further described herein, point cloud data may be encoded by a source device (e.g., source device 102 as described herein with respect to FIG. 1) that outputs a bitstream containing the encoded point cloud data. The source device may encode the point cloud data based on point cloud compression coding, for example, geometry-based point cloud compression (G-PCC) coding and/or video-based point cloud compression (V-PCC) coding, or next generation coding. A destination device (e.g., destination device 106 as described herein with respect to FIG. 1) receives the bitstream containing the point cloud data and decodes the bitstream containing the point cloud data. The destination device may decode the point cloud data by performing point cloud decompression coding. The decompression coding may be an inverse process of the point cloud compression coding. The point cloud decompression coding may include, for example, G-PCC coding. Decoding may be used to decompress the point cloud data for display and/or other forms of consumption (e.g., further analysis, storage, etc.). The destination device (or a different device) may include, for example, a renderer for rendering the decoded point cloud data. The renderer may output content, for example, by rendering the point cloud data. The renderer may output content, for example, by rendering the point cloud data along with other data (e.g., audio data).

One format for storing volumetric visual data may be point clouds. A point cloud may comprise a collection of points in 3D space. Each point in a point cloud may comprise geometry information that may indicate the point's position in 3D space. For example, the geometry information may indicate the point's position in 3D space, for example, using three Cartesian coordinates (x, y, and z) and/or using spherical coordinates (r, phi, theta) (e.g., if acquired by a rotating sensor). The positions of points in a point cloud may be quantized according to a space precision. The space precision may be the same or different in each dimension. The quantization process may create a grid in 3D space. One or more points residing within each sub-grid volume may be mapped to the sub-grid center coordinates, referred to as voxels. A voxel may be considered as a 3D extension of pixels corresponding to the 2D image grid coordinates. For example, similar to a pixel being the smallest unit in the example of dividing the 2D space (or 2D image) into discrete, uniform (e.g., equally sized) regions, a voxel may be the smallest unit of volume in the example of dividing 3D space into discrete, uniform regions. A point in a point cloud may comprise one or more types of attribute information. Attribute information may indicate a property of a point's visual appearance. For example, attribute information may indicate a texture (e.g., color) of the point, a material type of the point, transparency information of the point, reflectance information of the point, a normal vector to a surface of the point, a velocity at the point, an acceleration at the point, a time stamp indicating when the point was captured, or a modality indicating how the point was captured (e.g., running, walking, or flying). A point in a point cloud may comprise light field data in the form of multiple view-dependent texture information. Light field data may be another type of optional attribute information.

The points in a point cloud may describe an object or a scene. For example, the points in a point cloud may describe the external surface and/or the internal structure of an object or scene. The object or scene may be synthetically generated by a computer. The object or scene may be generated from the capture of a real-world object or scene. The geometry information of a real-world object or a scene may be obtained by 3D scanning and/or photogrammetry. 3D scanning may include different types of scanning, for example, laser scanning, structured light scanning, and/or modulated light scanning. 3D scanning may obtain geometry information. 3D scanning may obtain geometry information, for example, by moving one or more laser heads, structured light cameras, and/or modulated light cameras relative to an object or scene being scanned. Photogrammetry may obtain geometry information. Photogrammetry may obtain geometry information, for example, by triangulating the same feature or point in different spatially shifted 2D photographs. Point cloud data may take the form of a point cloud frame. The point cloud frame may describe an object or scene captured at a particular time instance. Point cloud data may take the form of a sequence of point cloud frames. The sequence of point cloud frames may be referred to as a point cloud sequence or point cloud video. The sequence of point cloud frames may describe an object or scene captured at multiple different time instances.

The data size of a point cloud frame or point cloud sequence may be excessive (e.g., too large) for storage and/or transmission in many applications. For example, a single point cloud may comprise over a million points or even billions of points. Each point may comprise geometry information and one or more optional types of attribute information. The geometry information of each point may comprise three Cartesian coordinates (x, y, and z) and/or spherical coordinates (r, phi, theta) that may be each represented, for example, using at least 10 bits per component or 30 bits in total. The attribute information of each point may comprise a texture corresponding to a plurality of (e.g., three) color components (e.g., R, G, and B color components). Each color component may be represented, for example, using 8-10 bits per component or 24-30 bits in total. For example, a single point may comprise at least 54 bits of information, with at least 30 bits of geometry information and at least 24 bits of texture. If a point cloud frame includes a million such points, each point cloud frame may require 54 million bits or 54 megabits to represent. For dynamic point clouds that change over time, at a frame rate of 30 frames per second, a data rate of 1.32 gigabits per second may be required to send (e.g., transmit) the points of the point cloud sequence. Raw representations of point clouds may require a large amount of data, and the practical deployment of point-cloud-based technologies may need compression technologies that enable the storage and distribution of point clouds with a reasonable cost.

Encoding may be used to compress and/or reduce the data size of a point cloud frame or point cloud sequence to provide for more efficient storage and/or transmission. Decoding may be used to decompress a compressed point cloud frame or point cloud sequence for display and/or other forms of consumption (e.g., by a machine learning based device, neural network-based device, artificial intelligence-based device, or other forms of consumption by other types of machine-based processing algorithms and/or devices). Compression of point clouds may be lossy (introducing differences relative to the original data) for the distribution to and visualization by an end-user, for example, on AR or VR glasses or any other 3D-capable device. Lossy compression may allow for a high ratio of compression but may imply a trade-off between compression and visual quality perceived by an end-user. Other frameworks, for example, frameworks for medical applications or autonomous driving, may require lossless compression to avoid altering the results of a decision obtained, for example, based on the analysis of the sent (e.g., transmitted) and decompressed point cloud frame.

FIG. 1 shows an example point cloud coding (e.g., encoding and/or decoding) system 100. Point cloud coding system 100 may comprise a source device 102, a transmission medium 104, and a destination device 106. Source device 102 may encode a point cloud sequence 108 into a bitstream 110 for more efficient storage and/or transmission. Source device 102 may store and/or send (e.g., transmit) bitstream 110 to destination device 106 via transmission medium 104. Destination device 106 may decode bitstream 110 to display point cloud sequence 108 or for other forms of consumption (e.g., further analysis, storage, etc.). Destination device 106 may receive bitstream 110 from source device 102 via a storage medium or transmission medium 104. Source device 102 and destination device 106 may include any number of different devices. Source device 102 and destination device 106 may include, for example, a cluster of interconnected computer systems acting as a pool of seamless resources (also referred to as a cloud of computers or cloud computer), a server, a desktop computer, a laptop computer, a tablet computer, a smart phone, a wearable device, a television, a camera, a video gaming console, a set-top box, a video streaming device, a vehicle (e.g., an autonomous vehicle), or a head-mounted display. A head-mounted display may allow a user to view a VR, AR, or MR scene and adjust the view of the scene, for example, based on movement of the user's head. A head-mounted display may be connected (e.g., tethered) to a processing device (e.g., a server, a desktop computer, a set-top box, or a video gaming console) or may be fully self-contained.

A source device 102 may comprise a point cloud source 112, an encoder 114, and an output interface 116. A source device 102 may comprise a point cloud source 112, an encoder 114, and an output interface 116, for example, to encode point cloud sequence 108 into a bitstream 110. Point cloud source 112 may provide (e.g., generate) point cloud sequence 108, for example, from a capture of a natural scene and/or a synthetically generated scene. A synthetically generated scene may be a scene comprising computer generated graphics. Point cloud source 112 may comprise one or more point cloud capture devices, a point cloud archive comprising previously captured natural scenes and/or synthetically generated scenes, a point cloud feed interface to receive captured natural scenes and/or synthetically generated scenes from a point cloud content provider, and/or a processor(s) to generate synthetic point cloud scenes. The point cloud capture devices may include, for example, one or more laser scanning devices, structured light scanning devices, modulated light scanning devices, and/or passive scanning devices.

Point cloud sequence 108 may comprise a series of point cloud frames 124 (e.g., an example shown in FIG. 1). A point cloud frame may describe an object or scene captured at a particular time instance. Point cloud sequence 108 may achieve the impression of motion by using a constant or variable time to successively present point cloud frames 124 of point cloud sequence 108. A point cloud frame may comprise a collection of points (e.g., voxels) 126 in 3D space. Each point 126 may comprise geometry information that may indicate the point's position in 3D space. The geometry information may indicate, for example, the point's position in 3D space using three Cartesian coordinates (x, y, and z). One or more of points 126 may comprise one or more types of attribute information. Attribute information may indicate a property of a point's visual appearance. For example, attribute information may indicate, for example, a texture (e.g., color) of a point, a material type of a point, transparency information of a point, reflectance information of a point, a normal vector to a surface of a point, a velocity at a point, an acceleration at a point, a time stamp indicating when a point was captured, a modality indicating how a point was captured (e.g., running, walking, or flying), etc. One or more of points 126 may comprise, for example, light field data in the form of multiple view-dependent texture information. Light field data may be another type of optional attribute information. Color attribute information of one or more of points 126 may comprise a luminance value and two chrominance values. The luminance value may represent the brightness (e.g., luma component, Y) of the point. The chrominance values may respectively represent the blue and red components of the point (e.g., chroma components, Cb and Cr) separate from the brightness. Other color attribute values may be represented, for example, based on different color schemes (e.g., an RGB or monochrome color scheme).

Encoder 114 may encode point cloud sequence 108 into a bitstream 110. To encode point cloud sequence 108, encoder 114 may use one or more lossless or lossy compression techniques to reduce redundant information in point cloud sequence 108. To encode point cloud sequence 108, encoder 114 may use one or more prediction techniques to reduce redundant information in point cloud sequence 108. Redundant information is information that may be predicted at a decoder 120 and may not be needed to be sent (e.g., transmitted) to decoder 120 for accurate decoding of point cloud sequence 108. For example, Motion Picture Expert Group (MPEG) introduced a geometry-based point cloud compression (G-PCC) standard (ISO/IEC standard 23090-9: Geometry-based point cloud compression). G-PCC specifies the encoded bitstream syntax and semantics for transmission and/or storage of a compressed point cloud frame and the decoder operation for reconstructing the compressed point cloud frame from the bitstream. During standardization of G-PCC, a reference software (ISO/IEC standard 23090-21: Reference Software for G-PCC) was developed to encode the geometry and attribute information of a point cloud frame. To encode geometry information of a point cloud frame, the G-PCC reference software encoder may perform voxelization. The G-PCC reference software encoder may perform voxelization, for example, by quantizing positions of points in a point cloud. Quantizing positions of points in a point cloud may create a grid in 3D space. The G-PCC reference software encoder may map the points to the center coordinates of the sub-grid volume (e.g., voxel) that their quantized locations reside in. The G-PCC reference software encoder may perform geometry analysis using an occupancy tree to compress the geometry information. The G-PCC reference software encoder may entropy encode the result of the geometry analysis to further compress the geometry information. To encode attribute information of a point cloud, the G-PCC reference software encoder may use a transform tool, such as Region Adaptive Hierarchical Transform (RAHT), the Predicting Transform, and/or the Lifting Transform. The Lifting Transform may be built on top of the Predicting Transform. The Lifting Transform may include an extra update/lifting step. The Lifting Transform and the Predicting Transform may be referred to as Predicting/Lifting Transform or pred lift. Encoder 114 may operate in a same or similar manner to an encoder provided by the G-PCC reference software.

Output interface 116 may be configured to write and/or store bitstream 110 onto transmission medium 104. The bitstream 110 may be sent (e.g., transmitted) to destination device 106. In addition or alternatively, output interface 116 may be configured to send (e.g., transmit), upload, and/or stream bitstream 110 to destination device 106 via transmission medium 104. Output interface 116 may comprise a wired and/or wireless transmitter configured to send (e.g., transmit), upload, and/or stream bitstream 110 according to one or more proprietary, open-source, and/or standardized communication protocols. The one or more proprietary, open-source, and/or standardized communication protocols may include, for example, Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, Wireless Application Protocol (WAP) standards, and/or any other communication protocol.

Transmission medium 104 may comprise a wireless, wired, and/or computer readable medium. For example, transmission medium 104 may comprise one or more wires, cables, air interfaces, optical discs, flash memory, and/or magnetic memory. In addition or alternatively, transmission medium 104 may comprise one or more networks (e.g., the Internet) or file server(s) configured to store and/or send (e.g., transmit) encoded video data.

Destination device 106 may decode bitstream 110 into point cloud sequence 108 for display or other forms of consumption. Destination device 106 may comprise one or more of an input interface 118, a decoder 120, and/or a point cloud display 122. Input interface 118 may be configured to read bitstream 110 stored on transmission medium 104. Bitstream 110 may be stored on transmission medium 104 by source device 102. In addition or alternatively, input interface 118 may be configured to receive, download, and/or stream bitstream 110 from source device 102 via transmission medium 104. Input interface 118 may comprise a wired and/or wireless receiver configured to receive, download, and/or stream bitstream 110 according to one or more proprietary, open-source, standardized communication protocols, and/or any other communication protocol. Examples of the protocols include Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, and Wireless Application Protocol (WAP) standards.

Decoder 120 may decode point cloud sequence 108 from encoded bitstream 110. For example, decoder 120 may operate in a same or similar manner as a decoder provided by G-PCC reference software. Decoder 120 may decode a point cloud sequence that approximates a point cloud sequence 108. Decoder 120 may decode a point cloud sequence that approximates a point cloud sequence 108 due to, for example, lossy compression of the point cloud sequence 108 by encoder 114 and/or errors introduced into encoded bitstream 110, for example, if transmission to destination device 106 occurs.

Point cloud display 122 may display a point cloud sequence 108 to a user. The point cloud display 122 may comprise, for example, a cathode rate tube (CRT) display, a liquid crystal display (LCD), a plasma display, a light emitting diode (LED) display, a 3D display, a holographic display, a head-mounted display, or any other display device suitable for displaying point cloud sequence 108.

Point cloud coding (e.g., encoding/decoding) system 100 is presented by way of example and not limitation. Point cloud coding systems different from the point cloud coding system 100 and/or modified versions of the point cloud coding system 100 may perform the methods and processes as described herein. For example, the point cloud coding system 100 may comprise other components and/or arrangements. Point cloud source 112 may, for example, be external to source device 102. Point cloud display device 122 may, for example, be external to destination device 106 or omitted altogether (e.g., if point cloud sequence 108 is intended for consumption by a machine and/or storage device). Source device 102 may further comprise, for example, a point cloud decoder. Destination device 106 may comprise, for example, a point cloud encoder. For example, source device 102 may be configured to further receive an encoded bit stream from destination device 106. Receiving an encoded bit stream from destination device 106 may support two-way point cloud transmission between the devices.

As described herein, an encoder may quantize the positions of points in a point cloud according to a space precision, which may be the same or different in each dimension of the points. The quantization process may create a grid in 3D space. The encoder may map any points residing within each sub-grid volume to the sub-grid center coordinates, referred to as a voxel or a volumetric pixel. A voxel may be considered as a 3D extension of pixels corresponding to 2D image grid coordinates.

An encoder may represent or code a point cloud (e.g., a voxelized point cloud). An encoder may represent or code a point cloud, for example, using an occupancy tree. For example, the encoder may split the initial volume or cuboid containing the point cloud into sub-cuboids. The initial volume or cuboid may be referred to as a bounding box. A cuboid may be, for example, a cube. The encoder may recursively split each sub-cuboid that contains at least one point of the point cloud. The encoder may not further split sub-cuboids that do not contain at least one point of the point cloud. A sub-cuboid that contains at least one point of the point cloud may be referred to as an occupied sub-cuboid. A sub-cuboid that does not contain at least one point of the point cloud may be referred to as an unoccupied sub-cuboid. The encoder may split an occupied sub-cuboid into, for example, two sub-cuboids (to form a binary tree), four sub-cuboids (to form a quadtree), or eight sub-cuboids (to form an octree). The encoder may split an occupied sub-cuboid to obtain further sub-cuboids. The sub-cuboids may have the same size and shape at a given depth level of the occupancy tree. The sub-cuboids may have the same size and shape at a given depth level of the occupancy tree, for example, if the encoder splits the occupied sub-cuboid along a plane passing through the middle of edges of the sub-cuboid.

The initial volume or cuboid containing the point cloud may correspond to the root node of the occupancy tree. Each occupied sub-cuboid, split from the initial volume, may correspond to a node (of the root node) in a second level of the occupancy tree. Each occupied sub-cuboid, split from an occupied sub-cuboid in the second level, may correspond to a node (off the occupied sub-cuboid in the second level from which it was split) in a third level of the occupancy tree. The occupancy tree structure may continue to form in this manner for each recursive split iteration until, for example, some maximum depth level of the occupancy tree is reached or each occupied sub-cuboid has a volume corresponding to one voxel.

Each non-leaf node of the occupancy tree may comprise or be associated with an occupancy word representing the occupancy state of the cuboid corresponding to the node. For example, a node of the occupancy tree corresponding to a cuboid that is split into 8 sub-cuboids may comprise or be associated with a 1-byte occupancy word. Each bit (referred to as an occupancy bit) of the 1-byte occupancy word may represent or indicate the occupancy of a different one of the eight sub-cuboids. Occupied sub-cuboids may be each represented or indicated by a binary “1” in the 1-byte occupancy word. Unoccupied sub-cuboids may be each represented or indicated by a binary “0” in the 1-byte occupancy word. Occupied and un-occupied sub-cuboids may be represented or indicated by opposite 1-bit binary values (e.g., a binary “0” representing or indicating an occupied sub-cuboid and a binary “1” representing or indicating an unoccupied sub-cuboid) in the 1-byte occupancy word.

Each bit of an occupancy word may represent or indicate the occupancy of a different one of the eight sub-cuboids. Each bit of an occupancy word may represent or indicate the occupancy of a different one of the eight sub-cuboids, for example, following the so-called Morton order. For example, the least significant bit of an occupancy word may represent or indicate, for example, the occupancy of a first one of the eight sub-cuboids following the Morton order. The second least significant bit of an occupancy word may represent or indicate, for example, the occupancy of a second one of the eight sub-cuboids following the Morton order, etc.

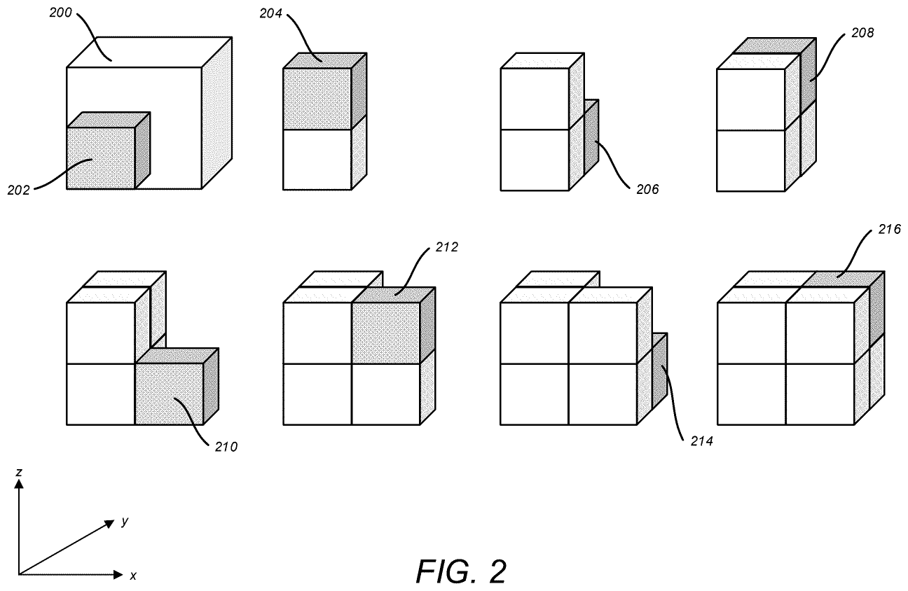

FIG. 2 shows an example Morton order. More specifically, FIG. 2 shows a Morton order of eight sub-cuboids 202-216 split from a cuboid 200. Sub-cuboids 202-216 may be labeled, for example, based on their Morton order, with child node 202 being the first in Morton order and child node 216 being the last in Morton order. The Morton order for sub-cuboids 202-216 may be a local lexicographic order in xyz.

The geometry of a point cloud may be represented by, and may be determined from, the initial volume and the occupancy words of the nodes in an occupancy tree. An encoder may send (e.g., transmit) the initial volume and the occupancy words of the nodes in the occupancy tree in a bitstream to a decoder for reconstructing the point cloud. The encoder may entropy encode the occupancy words. The encoder may entropy encode the occupancy words, for example, before sending (e.g., transmitting) the initial volume and the occupancy words of the nodes in the occupancy tree. The encoder may encode an occupancy bit of an occupancy word of a node corresponding to a cuboid. The encoder may encode an occupancy bit of an occupancy word of a node corresponding to a cuboid, for example, based on one or more occupancy bits of occupancy words of other nodes corresponding to cuboids that are adjacent or spatially close to the cuboid of the occupancy bit being encoded.

An encoder and/or a decoder may code (e.g., encode and/or decode) occupancy bits of occupancy words in sequence of a scan order. The scan order may also be referred to as a scanning order. For example, an encoder and/or a decoder may scan an occupancy tree in breadth-first order. All the occupancy words of the nodes of a given depth (e.g., level) within the occupancy tree may be scanned. All the occupancy words of the nodes of a given depth (e.g., level) within the occupancy tree may be scanned, for example, before scanning the occupancy words of the nodes of the next depth (e.g., level). Within a given depth, the encoder and/or decoder may scan the occupancy words of nodes in the Morton order. Within a given node, the encoder and/or decoder may scan the occupancy bits of the occupancy word of the node further in the Morton order.

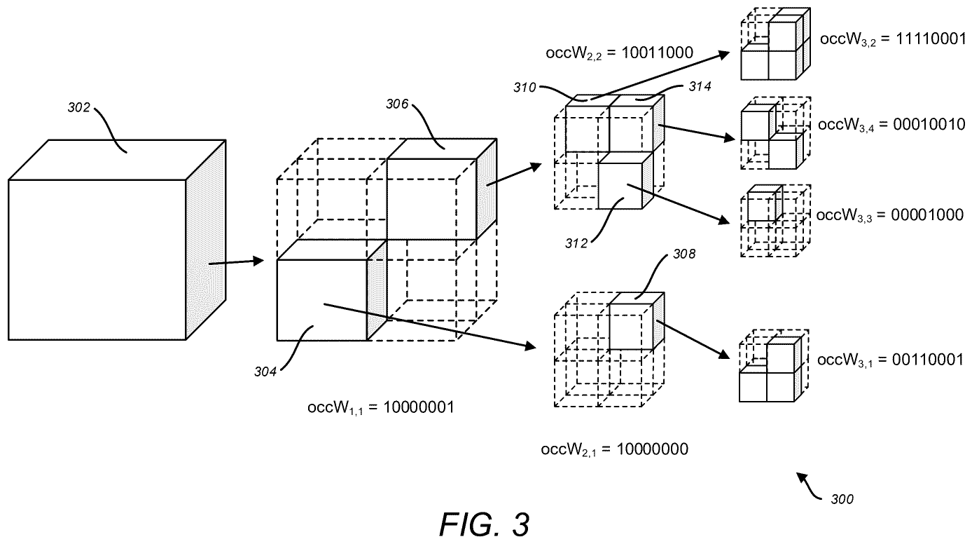

FIG. 3 shows an example scanning order. FIG. 3 shows an example scanning order (e.g., breadth-first order as described herein) for an occupancy tree 300. More specifically, FIG. 3 shows a scanning order for the first three example levels of an occupancy tree 300. In FIG. 3, a cuboid (e.g., cube) 302 corresponding to a root node of the occupancy tree 300 may be divided into eight sub-cuboids (e.g., sub-cubes). Two sub-cuboids 304 and 306 of the eight sub-cuboids may be occupied. The other six sub-cuboids of the eight sub-cuboids may be unoccupied. Following the Morton order, a first eight-bit occupancy word (e.g., occW_{1,1}) may be constructed to represent the occupancy word of the root node. An (e.g., each) occupancy bit of the first eight-bit occupancy word (e.g., occW_{1,1}) may represent or indicate the occupancy of a sub-cube of the eight sub-cuboids in the Morton order. For example, the least significant occupancy bit of the first eight-bit occupancy word occW_{1,1} may represent or indicate the occupancy of the first sub-cuboid of the eight sub-cuboids in the Morton order. The second least significant occupancy bit of the first eight-bit occupancy word occW_{1,1} may represent or indicate the occupancy of the second sub-cuboid of the eight sub-cuboids in the Morton order, etc.

Each of occupied sub-cuboids (e.g., two occupied sub-cuboids 304 and 306) may correspond to a node off the root node in a second level of an occupancy tree 300. The occupied sub-cuboids (e.g., two occupied sub-cuboids 304 and 306) may be each further split into eight sub-cuboids. For example, one of the sub-cuboids 308 of the eight sub-cuboids split from the sub-cube 304 may be occupied, and the other seven sub-cuboids may be unoccupied. Three of the sub-cuboids 310, 312, and 314 of the eight sub-cuboids split from the sub-cube 306 may be occupied, and the other five sub-cuboids of the eight sub-cuboids split from the sub-cube 306 may be unoccupied. Two second eight-bit occupancy words occW_{2,1} and occW_{2,2} may be constructed in this order to respectively represent the occupancy word of the node corresponding to the sub-cuboid 304 and the occupancy word of the node corresponding to the sub-cuboid 306.

Each of occupied sub-cuboids (e.g., four occupied sub-cuboids 308, 310, 312, and 314) may correspond to a node in a third level of an occupancy tree 300. The occupied sub-cuboids (e.g., four occupied sub-cuboids 308, 310, 312, and 314) may be each further split into eight sub-cuboids or 32 sub-cuboids in total. For example, four third level eight-bit occupancy words occW_{3,1,} occW_{3,2}, occW_{3,3} and occW_{3,4} may be constructed in this order to respectively represent the occupancy word of the node corresponding to the sub-cuboid 308, the occupancy word of the node corresponding to the sub-cuboid 310, the occupancy word of the node corresponding to the sub-cuboid 312, and the occupancy word of the node corresponding to the sub-cuboid 314.

Occupancy words of an example occupancy tree 300 may be entropy coded (e.g., entropy encoded by an encoder and/or entropy decoded by a decoder), for example, following the scanning order discussed herein (e.g., Morton order). The occupancy words of the example occupancy tree 300 may be entropy coded (e.g., entropy encoded by an encoder and/or entropy decoded by a decoder) as the succession of the seven occupancy words occW_{1,1} to occW_{3,4}, for example, following the scanning order discussed herein. The scanning order discussed herein may be a breadth-first scanning order. The occupancy word(s) of all node(s) having the same depth (or level) as a current parent node may have already been entropy coded, for example, if the occupancy word of a current child node belonging to the current parent node is being entropy coded. For example, the occupancy word(s) of all node(s) having the same depth (e.g., level) as the current child node and having a lower Morton order than the current child node may have also already been entropy coded. Part of the already coded occupancy word(s) may be used to entropy code the occupancy word of the current child node. The already coded occupancy word(s) of neighboring parent and child node(s) may be used, for example, to entropy code the occupancy word of the current child node. The occupancy bit(s) of the occupancy word having a lower Morton order than a particular occupancy bit may have also already been entropy coded and may be used to code the occupancy bit of the occupancy word of the current child node, for example, if the particular occupancy bit of the occupancy word of the current child node is being coded (e.g., entropy coded).

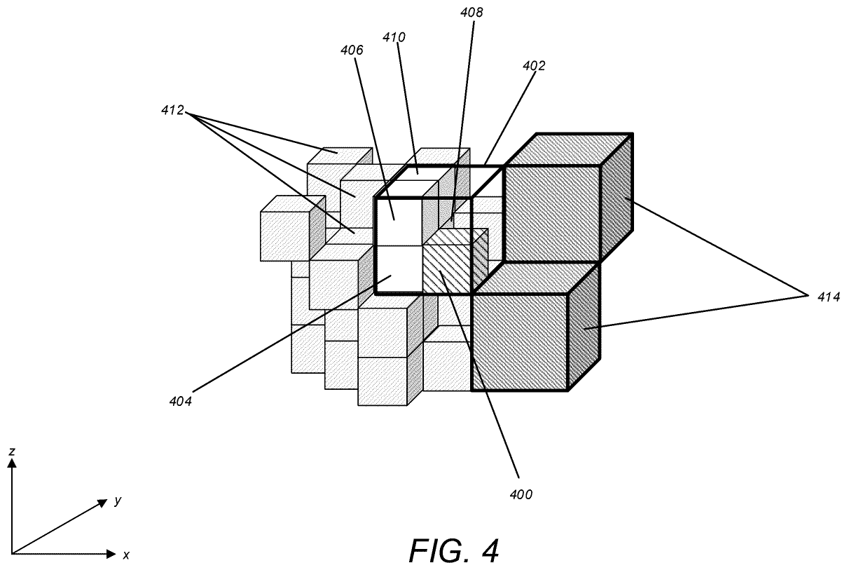

FIG. 4 shows an example neighborhood of cuboids for entropy coding the occupancy of a child cuboid. More specifically, FIG. 4 shows an example neighborhood of cuboids with already-coded occupancy bits. The neighborhood of cuboids with already-coded occupancy bits may be used to entropy code the occupancy bit of a current child cuboid 400. The neighborhood of cuboids with already-coded occupancy bits may be determined, for example, based on the scanning order of an occupancy tree representing the geometry of the cuboids in FIG. 4 as discussed herein. The neighborhood of cuboids, of a current child cuboid, may include one or more of: a cuboid adjacent to the current child cuboid, a cuboid sharing a vertex with the current child cuboid, a cuboid sharing an edge with the current child cuboid, a cuboid sharing a face with the current child cuboid, a parent cuboid adjacent to the current child cuboid, a parent cuboid sharing a vertex with the current child cuboid, a parent cuboid sharing an edge with the current child cuboid, a parent cuboid sharing a face with the current child cuboid, a parent cuboid adjacent to the current parent cuboid, a parent cuboid sharing a vertex with the current parent cuboid, a parent cuboid sharing an edge with the current parent cuboid, a parent cuboid sharing a face with the current parent cuboid, etc. As shown in FIG. 4, current child cuboid 400 may belong to a current parent cuboid 402. Following the scanning order of the occupancy words and occupancy bits of nodes of the occupancy tree, the occupancy bits of four child cuboids 404, 406, 408, and 410, belonging to the same current parent cuboid 402, may have already been coded. The occupancy bit of child cuboids 412 of preceding parent cuboids may have already been coded. The occupancy bits of parent cuboids 414, for which the occupancy bits of child cuboids have not already been coded, may have already been coded. The already-coded occupancy bits of cuboids 404, 406, 408, 410, 412, and 414 may be used to code the occupancy bit of the current child cuboid 400.

The number (e.g., quantity) of possible occupancy configurations (e.g., sets of one or more occupancy words and/or occupancy bits) for a neighborhood of a current child cuboid may be 2^{N}, where N is the number (e.g., quantity) of cuboids in the neighborhood of the current child cuboid with already-coded occupancy bits. The neighborhood of the current child cuboid may comprise several dozens of cuboids. The neighborhood of the current child cuboid (e.g., several dozens of cuboids) may comprise 26 adjacent parent cuboids sharing a face, an, edge, and/or a vertex with the parent cuboid of the current child cuboid and also several adjacent child cuboids having occupancy bits already coded sharing a face, an edge, or a vertex with the current child cuboid. The occupancy configuration for a neighborhood of the current child cuboid may have billions of possible occupancy configurations, even limited to a subset of the adjacent cuboids, making its direct use impractical. An encoder and/or decoder may use the occupancy configuration for a neighborhood of the current child cuboid to select the context (e.g., a probability model), among a set of contexts, of a binary entropy coder (e.g., binary arithmetic coder) that may code the occupancy bit of the current child cuboid. The context-based binary entropy coding may be similar to the Context Adaptive Binary Arithmetic Coder (CABAC) used in MPEG-H Part 2 (also known as High Efficiency Video Coding (HEVC)).

An encoder and/or a decoder may use several methods to reduce the occupancy configurations for a neighborhood of a current child cuboid being coded to a practical number (e.g., quantity) of reduced occupancy configurations. The 26 or 64 occupancy configurations of the six adjacent parent cuboids sharing a face with the parent cuboid of the current child cuboid may be reduced to 9 occupancy configurations. The occupancy configurations may be reduced by using geometry invariance. An occupancy score for the current child cuboid may be obtained from the 226 occupancy configurations of the 26 adjacent parent cuboids. The score may be further reduced into a ternary occupancy prediction (e.g., “predicted occupied,” “unsure”, or “predicted unoccupied”) by using score thresholds. The number (e.g., quantity) of occupied adjacent child cuboids and the number (e.g., quantity) of unoccupied adjacent child cuboids may be used instead of the individual occupancies of these child cuboids.

An encoder and/or a decoder using/employing one or more of the methods described herein may reduce the number (e.g., quantity) of possible occupancy configurations for a neighborhood of a current child cuboid to a more manageable number (e.g., a few thousands). It has been observed that instead of associating a reduced number (e.g., quantity) of contexts (e.g., probability models) directly to the reduced occupancy configurations, another mechanism may be used, namely Optimal Binary Coders with Update on the Fly (OBUF). An encoder and/or a decoder may implement OBUF to limit the number (e.g., quantity) of contexts to a lower number (e.g., 32 contexts).

OBUF may use a limited number (e.g., 32) of contexts (e.g., probability models). The number (e.g., quantity) of contexts in OBUF may be a fixed number (e.g., fixed quantity). The contexts used by OBUF may be ordered, referred to by a context index (e.g., a context index in the range of 0 to 31), and associated from a lowest virtual probability to a highest virtual probability to code a “1”. A Look-Up Table (LUT) of context indices may be initialized at the beginning of a point cloud coding process. For example, the LUT may initially point to a context (e.g., with a context index 15) with the median virtual probability to code a “1” for all input. The LUT may initially point to a context with the median virtual probability to code a “1”, among the limited number (e.g., quantity) of contexts, for all input. This LUT may take an occupancy configuration for a neighborhood of current child cuboid as input and output the context index associated with the occupancy configuration. The LUT may have as many entries as reduced occupancy configurations (e.g., around a few thousand entries). The coding of the occupancy bit of a current child cuboid may comprise steps including determining the reduced occupancy configuration of the current child node, obtaining a context index by using the reduced occupancy configuration as an entry to the LUT, coding the occupancy bit of the current child cuboid by using the context pointed to (or indicated) by the context index, and updating the LUT entry corresponding to the reduced occupancy configuration, for example, based on the value of the coded occupancy bit of the current child cuboid. The LUT entry may be decreased to a lower context index value, for example, if a binary “0” (e.g., indicating the current child cuboid is unoccupied) is coded. The LUT entry may be increased to a higher context index value, for example, if a binary “1” (e.g., indicating the current child cuboid is occupied) is coded. The update process of the context index may be, for example, based on a theoretical model of optimal distribution for virtual probabilities associated with the limited number (e.g., quantity) of contexts. This virtual probability may be fixed by a model and may be different from the internal probability of the context that may evolve, for example, if the coding of bits of data occurs. The evolution of the internal context may follow a well-known process similar to the process in CABAC.

An encoder and/or a decoder may implement a “dynamic OBUF” scheme. The “dynamic OBUF” scheme may enable an encoder and/or a decoder to handle a much larger number (e.g., quantity) of occupancy configurations for a neighborhood of a current child cuboid, for example, than general OBUF. The use of a larger number (e.g., quantity) of occupancy configurations for a neighborhood of a current child cuboid may lead to improved compression capabilities, and may maintain complexity within reasonable bounds. By using an occupancy tree compressed by OBUF, an encoder and/or a decoder may reach a lossless compression performance as good as 1 bit per point (bpp) for coding the geometry of dense point clouds. An encoder and/or a decoder may implement dynamic OBUF to potentially further reduce the bit rate by more than 25% to 0.7 bpp.

OBUF may not take as input a large variety of reduced occupancy configurations for a neighborhood of a current child cuboid, and may potentially cause a loss of useful correlation. With OBUF, the size of the LUT of context indices may be increased to handle more various occupancy configurations for a neighborhood of a current child cuboid as input. Due to such increase, statistics may be diluted, and compression performance may be worsened. For example, if the LUT has millions of entries and the point cloud has a hundred thousand points, then most of the entries may be never visited (e.g., looked up, accessed, etc.). Many entries may be visited only a few times and their associated context index may not be updated enough times to reflect any meaningful correlation between the occupancy configuration value and the probability of occupancy of the current child cuboid. Dynamic OBUF may be implemented to mitigate the dilution of statistics due to the increase of the number (e.g., quantity) of occupancy configurations for a neighborhood of a current child cuboid. This mitigation may be performed by a “dynamic reduction” of occupancy configurations in dynamic OBUF.

Dynamic OBUF may add an extra step of reduction of occupancy configurations for a neighborhood of a current child cuboid, for example, before using the LUT of context indices. This step may be called a dynamic reduction because it evolves, for example, based on the progress of the coding of the point cloud or, more precisely, based on already visited (e.g., looked up in the LUT) occupancy configurations.

As discussed herein, many possible occupancy configurations for a neighborhood of a current child cuboid may be potentially involved but only a subset may be visited if the coding of a point cloud occurs. This subset may characterize the type of the point cloud. For example, most of the visited occupancy configurations may exhibit occupied adjacent cuboids of a current child cuboid, for example, if AR or VR dense point clouds are being coded. On the other hand, most of the visited occupancy configurations may exhibit only a few occupied adjacent cuboids of a current child cuboid, for example, if sensor-acquired sparse point clouds are being coded. The role of the dynamic reduction may be to obtain a more precise correlation, for example, based on the most visited occupancy configuration while putting aside (e.g., reducing aggressively) other occupancy configurations that are much less visited. The dynamic reduction may be updated on-the-fly. The dynamic reduction may be updated on-the-fly, for example, after each visit (e.g., a lookup in the LUT) of an occupancy configuration, for example, if the coding of occupancy data occurs.

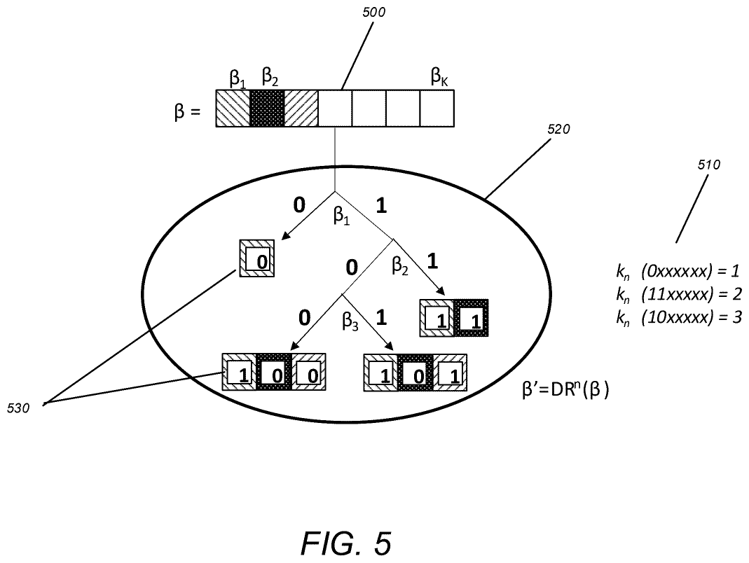

FIG. 5 shows an example of a dynamic reduction function DR that may be used in dynamic OBUF. The dynamic reduction function DR may be obtained by masking bits βⱼ of occupancy configurations 500

β=β₁ . . . β_{K}

made of K bits. The size of the mask may decrease, for example, if occupancy configurations are visited (e.g., looked up in the LUT) a certain number (e.g., quantity) of times. The initial dynamic reduction function DR⁰ may mask all bits for all occupancy configurations such that it is a constant function DR⁰(β)=0 for all occupancy configurations β. The dynamic reduction function may evolve from a function DRⁿ to an updated function DRⁿ⁺¹. The dynamic reduction function may evolve from a function DRⁿ to an updated function DRⁿ⁺¹, for example, after each coding of an occupancy bit. The function may be defined by

β′=DRⁿ(β)=β₁ . . . β_{kn(β)}

where kₙ(β) 510 is the number (e.g., quantity) of non-masked bits. The initialization of DR⁰ may correspond to k₀(β)=0, and the natural evolution of the reduction function toward finer statistics may lead to an increasing number (e.g., quantity) of non-masked bits kₙ(β)≤kₙ₊₁(β). The dynamic reduction function may be entirely determined by the values of kₙ for all occupancy configurations β.

The visits (e.g., instances of a lookup in the LUT) to occupancy configurations may be tracked by a variable NV(β′) for all dynamically reduced occupancy configurations β′=DRⁿ(β). The corresponding number (e.g., quantity) of visits NV(β^{V′}) may be increased by one, for example, after each instance of coding of an occupancy bit based on an occupancy configuration β^{V}. If this number (e.g., quantity) of visits NV(β^{V′}) is greater than a threshold thᵥ,

NV(β^{V′})>thᵥ

then the number (e.g., quantity) of unmasked bits kₙ(β) may be increased by one for all occupancy configurations β being dynamically reduced to β^{V′}. This corresponds to replacing the dynamically reduced occupancy configuration β^{V′} by the two new dynamically reduced occupancy configurations β^{0′} and β^{1′} defined by

β^{0′}=β^{V′}0=β^{V}₁ . . . β^{V}_{kn(β)}0 and β^{1′}=β^{V′}1=β^{V}₁ . . . β^{V}_{kn(β)}1.

In other words, the number (e.g., quantity) of unmasked bits has been increased by one kₙ₊₁(β)=kₙ(β)+1 for all occupancy configurations β such that DRⁿ(β)=β^{V′}. The number (e.g., quantity) of visits of the two new dynamically reduced occupancy configurations may be initialized to zero

NV(β^{0′})=NV(β^{1′})=0. (I)

At the start of the coding, the initial number (e.g., quantity) of visits for the initial dynamic reduction function DR⁰ may be set to

NV(DR⁰(β))=NV(0)=0,

and the evolution of NV on dynamically reduced occupancy configurations may be entirely defined.

The corresponding LUT entry LUT[β^{V′}] may be replaced by the two new entries LUT[β^{0′}] and LUT[β^{1′}] that are initialized by the coder index associated with β^{V′}. The corresponding LUT entry LUT[β^{V′}] may be replaced by the two new entries LUT[B^{0′}] and LUT[β^{1′}] that are initialized by the coder index associated with β^{V′}, for example, if a dynamically reduced occupancy configuration β^{V′} is replaced by the two new dynamically reduced occupancy configurations β^{0′} and β^{1′},

LUT[β^{0′}]=LUT[β^{1′}]=LUT[β^{V′}], (II)

and then evolve separately. The evolution of the LUT of coder indices on dynamically reduced occupancy configurations may be entirely defined.

The reduction function DRⁿ may be modeled by a series of growing binary trees Tⁿ 520 whose leaf nodes 530 are the reduced occupancy configurations β′=DRⁿ(β). The initial tree may be the single root node associated with 0=DR⁰(β). The replacement of the dynamically reduced to β^{V′} by β^{0′} and β^{1′} may correspond to growing the tree Tⁿ from the leaf node associated with β^{V′}, for example, by attaching to it two new nodes associated with β^{0′} and β^{1′}. The tree Tⁿ⁺¹ may be obtained by this growth. The number (e.g., quantity) of visits NV and the LUT of context indices may be defined on the leaf nodes and evolve with the growth of the tree through equations (I) and (II).

The practical implementation of dynamic OBUF may be made by the storage of the array NV[β′] and the LUT[β′] of context indices, as well as the trees Tⁿ 520. An alternative to the storage of the trees may be to store the array kₙ[β] 510 of the number (e.g., quantity) of non-masked bits.

A limitation for implementing dynamic OBUF may be its memory footprint. In some applications, a few million occupancy configurations may be practically handled, leading to about 20 bits βᵢ constituting an entry configuration β to the reduction function DR. Each bit βᵢ may correspond to the occupancy status of a neighboring cuboid of a current child cuboid or a set of neighboring cuboids of a current child cuboid.

Higher (e.g., more significant) bits βᵢ (e.g., β₀, β₁, etc.) may be the first bits to be unmasked. Higher (e.g., more significant) bits βᵢ (e.g., β₀, β₁, etc.) may be the first bits to be unmasked, for example, during the evolution of the dynamic reduction function DR. The order of neighbor-based information put in the bits βᵢ may impact the compression performance. Neighboring information may be ordered from higher (e.g., highest) priority to lower priority and put in this order into the bits βᵢ, from higher to lower weight. The priority may be, from the most important to the least important, occupancy of sets of adjacent neighboring child cuboids, then occupancy of adjacent neighboring child cuboids, then occupancy of adjacent neighboring parent cuboids, then occupancy of non-adjacent neighboring child nodes, and finally occupancy of non-adjacent neighboring parent nodes. Adjacent nodes sharing a face with the current child node may also have higher priority than adjacent nodes sharing an edge (but not sharing a face) with the current child node. Adjacent nodes sharing an edge with the current child node may have higher priority than adjacent nodes sharing only a vertex with the current child node.

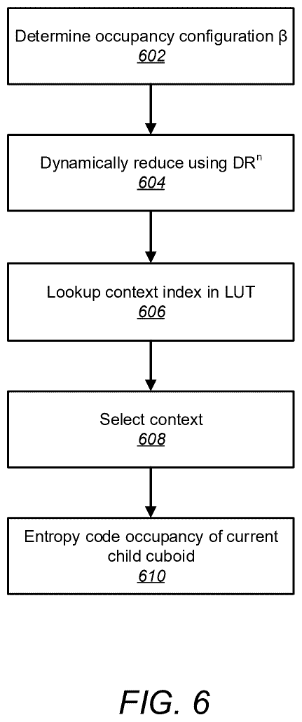

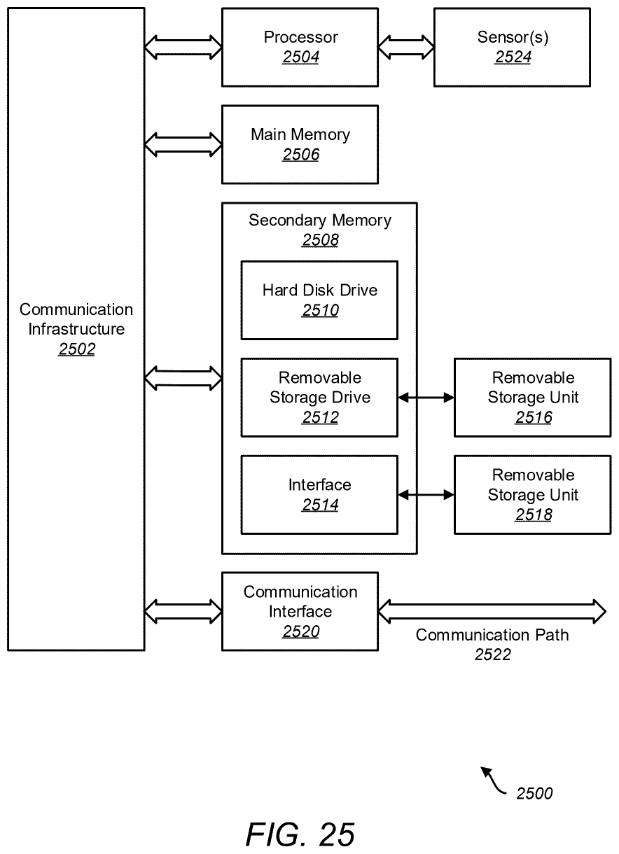

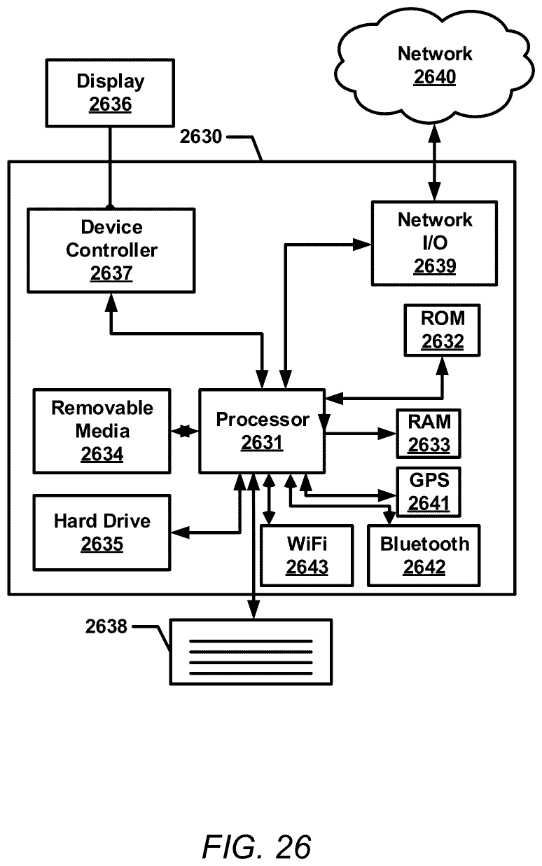

FIG. 6 shows an example method for coding occupancy of a cuboid using dynamic OBUF. More specifically, FIG. 6 shows an example method for coding occupancy bit of a current child cuboid using dynamic OBUF. One or more steps of FIG. 6 may be performed by an encoder and/or a decoder (e.g., the encoder 114 and/or decoder 120 in FIG. 1). All or portions of the flowchart may be implemented by a coder (e.g., the encoder 114 and/or decoder 120 in FIG. 1), an example computer system 2500 in FIG. 25, and/or an example computing device 2630 in FIG. 26.

At step 602, an occupancy configuration (e.g., occupancy configuration β) of the current child cuboid may be determined. The occupancy configuration (e.g., occupancy configuration) of the current child cuboid may be determined, for example, based on occupancy bits of already-coded cuboids in a neighborhood of the current child cuboid. At step 604, the occupancy configuration (e.g., occupancy configuration B) may be dynamically reduced. The occupancy configuration may be dynamically reduced, for example, using a dynamic reduction function DRⁿ. For example, the occupancy configuration β may be dynamically reduced into a reduced occupancy configuration β′=DRⁿ(β). At step 606, context index may be looked up, for example, in a look-up table (LUT). For example, the encoder and/or decoder may look up context index LUT[β′] in the LUT of the dynamic OBUF. At step 608, context (e.g., probability model) may be selected. For example, the context (e.g., probability model) pointed to by the context index may be selected. At step 610, occupancy of the current child cuboid may be entropy coded. For example, the occupancy bit of the current child cuboid may be entropy coded (e.g., arithmetic coded), for example, based on the context. The occupancy bit of the current child cuboid may be coded based on the occupancy bits of the already-coded cuboids neighboring the current child cuboid.

Although not shown in FIG. 6, the encoder and/or decoder may update the reduction function and/or update the context index. For example, the encoder and/or decoder may update the reduction function DRⁿ into DRⁿ⁺¹ and/or update the context index LUT[β'], for example, based on the occupancy bit of the current child cuboid. The method of FIG. 6 may be repeated for additional or all child cuboids of parent cuboids corresponding to nodes of the occupancy tree in a scan order, such as the scan order discussed herein with respect to FIG. 3.

In general, the occupancy tree is a lossless compression technique. The occupancy tree may be adapted to provide lossy compression, for example, by modifying the point cloud on the encoder side (e.g., down-sampling, removing points, moving points, etc.). The performance of the lossy compression may be weak. The lossy compression may be a useful lossless compression technique for dense point clouds.

One approach to lossy compression for point cloud geometry may be to set the maximum depth of the occupancy tree to not reach the smallest volume size of one voxel but instead to stop at a bigger volume size (e.g., N×N×N cuboids (e.g., cubes), where N>1). The geometry of the points belonging to each occupied leaf node associated with the bigger volumes may then be modeled. This approach may be particularly suited for dense and smooth point clouds that may be locally modeled by smooth functions such as planes or polynomials. The coding cost may become the cost of the occupancy tree plus the cost of the local model in each of the occupied leaf nodes.

A scheme for modeling the geometry of the points belonging to each occupied leaf node associated with a volume size larger than one voxel may use sets of triangles as local models. The scheme may be referred to as the “TriSoup” scheme. TriSoup is short for “Triangle Soup” because the connectivity between triangles may not be part of the models. An occupied leaf node of an occupancy tree that corresponds to a cuboid with a volume greater than one voxel may be referred to as a TriSoup node. An edge belonging to at least one cuboid corresponding to a TriSoup node may be referred to as a TriSoup edge. A TriSoup node may comprise a presence flag (sₖ) for each TriSoup edge of its corresponding occupied cuboid. A presence flag (sₖ) of a TriSoup edge may indicate whether a TriSoup vertex (Vₖ) is present or not on the TriSoup edge. At most one TriSoup vertex (Vₖ) may be present on a TriSoup edge. For each vertex (Vₖ) present on a TriSoup edge of an occupied cuboid, the TriSoup node corresponding to the occupied cuboid may comprise a position (pₖ) of the vertex (Vₖ) along the TriSoup edge.

In addition to the occupancy words of an occupancy tree, an encoder may entropy encode, for each TriSoup node of the occupancy tree, the TriSoup vertex presence flags and positions of each TriSoup edge belonging to TriSoup nodes of the occupancy tree. A decoder may similarly entropy decode the TriSoup vertex presence flags and positions of each TriSoup edge and vertex along a respective TriSoup edge belonging to a TriSoup node of the occupancy tree, in addition to the occupancy words of the occupancy tree.

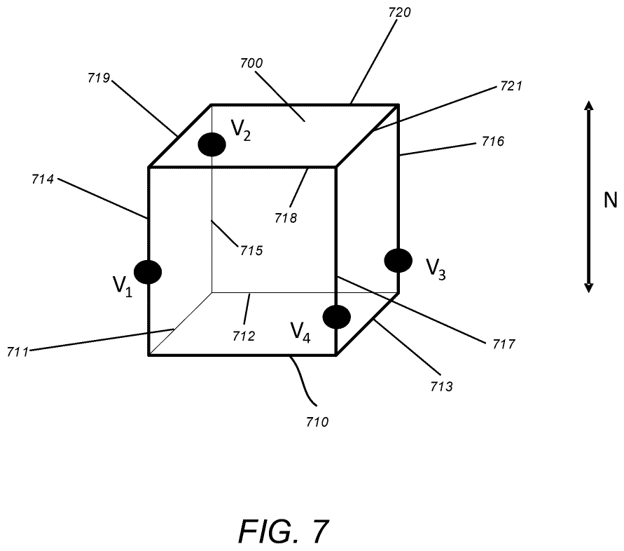

FIG. 7 shows an example of an occupied cuboid (e.g., cube) 700. More specifically, FIG. 7 shows an example of an occupied cuboid (e.g., cube) 700 of size N×N×N (where N>1) that corresponds to a TriSoup node of an occupancy tree. An occupied cuboid 700 may comprise edges (e.g., TriSoup edges 710-721). The TriSoup node, corresponding to the occupied cuboid 700, may comprise a presence flag (sₖ) for each edge (e.g., each TriSoup edge of the TriSoup edges 710-721). For example, the presence flag of a TriSoup edge 714 may indicate that a TriSoup vertex V₁ is present on the TriSoup edge 714. The presence flag of a TriSoup edge 715 may indicate that a TriSoup vertex V₂ is present on the TriSoup edge 715. The presence flag of a TriSoup edge 716 may indicate that a TriSoup vertex V₃ is present on the TriSoup edge 716. The presence flag of a TriSoup edge 717 may indicate that a TriSoup vertex V₄ is present on the TriSoup edge 717. The presence flags of the remaining TriSoup edges each may indicate that a TriSoup vertex is not present on their corresponding TriSoup edge. The TriSoup node, corresponding to the occupied cuboid 700, may comprise a position for each TriSoup vertex present along one of its TriSoup edges 710-721. More specifically, the TriSoup node, corresponding to the occupied cuboid 700, may comprise a position p₁ for TriSoup vertex V₁, a position p₂ for TriSoup vertex V₂, a position p₃ for TriSoup vertex V₃, and a position p₄ for TriSoup vertex V₄. The TriSoup vertices may be shared among TriSoup nodes along common TriSoup edge(s).

A presence flag (sₖ) and, if the presence flag (sₖ) may indicate the presence of a vertex, a position (pₖ) of a current TriSoup edge may be entropy coded. The presence flag (sₖ) and position (pₖ) may be individually or collectively referred to as vertex information or TriSoup vertex information. A presence flag (sₖ) and, if the presence flag (sₖ) indicates the presence of a vertex, a position (pₖ) of a current TriSoup edge may be entropy coded, for example, based on already-coded presence flags and positions, of present TriSoup vertices, of TriSoup edges that neighbor the current TriSoup edge. A presence flag (sₖ) and, if the presence flag (sₖ) may indicate the presence of a vertex, a position (pₖ) of a current TriSoup edge (e.g., indicating a position of the vertex the edge is along) may be additionally or alternatively entropy coded. The presence flag (sₖ) and the position (pₖ) of a current TriSoup edge may be additionally or alternatively entropy coded, for example, based on occupancies of cuboids that neighbor the current TriSoup edge. Similar to the entropy coding of the occupancy bits of the occupancy tree, a configuration β_{TS} for a neighborhood (also referred to as a neighborhood configuration β_{TS}) of a current TriSoup edge may be obtained and dynamically reduced into a reduced configuration β_{TS}′=DRⁿ(β_{TS}), for example, by using a dynamic OBUF scheme for TriSoup. A context index LUT[β_{TS}′] may be obtained from the OBUF LUT. At least a part of the vertex information of the current TriSoup edge may be entropy coded using the context (e.g., probability model) pointed to by the context index.

The TriSoup vertex position (pₖ) (if present) along its TriSoup edge may be binarized. The TriSoup vertex position (pₖ) (if present) along its TriSoup edge may be binarized, for example, to use a binary entropy coder to entropy code at least part of the vertex information of the current TriSoup edge. A number (e.g., quantity) of bits N_{b} may be set for the quantization of the TriSoup vertex position (pₖ) along the TriSoup edge of length N. The TriSoup edge of length N may be uniformly divided into 2^{Nb} quantization intervals. By doing so, the TriSoup vertex position (pₖ) may be represented by N_{b} bits (pₖ^{j}, j=1, . . . , N_{b}) that may be individually coded by the dynamic OBUF scheme as well as the bit corresponding to the presence flag (sₖ). The neighborhood configuration β_{TS}, the OBUF reduction function DRⁿ, and the context index may depend on the nature, characteristic, and/or property of the coded bit (e.g., a presence flag (sₖ), a highest position bit (pₖ₁), a second highest position bit (pₖ₂), etc.) of the coded bit (e.g., presence flag (sₖ), highest position bit (pₖ¹), second highest position bit (pₖ²), etc.). There may practically be several dynamic OBUF schemes, each dedicated to a specific bit of information (e.g., presence flag (sₖ) or position bit (pₖ^{j})) of the vertex information.

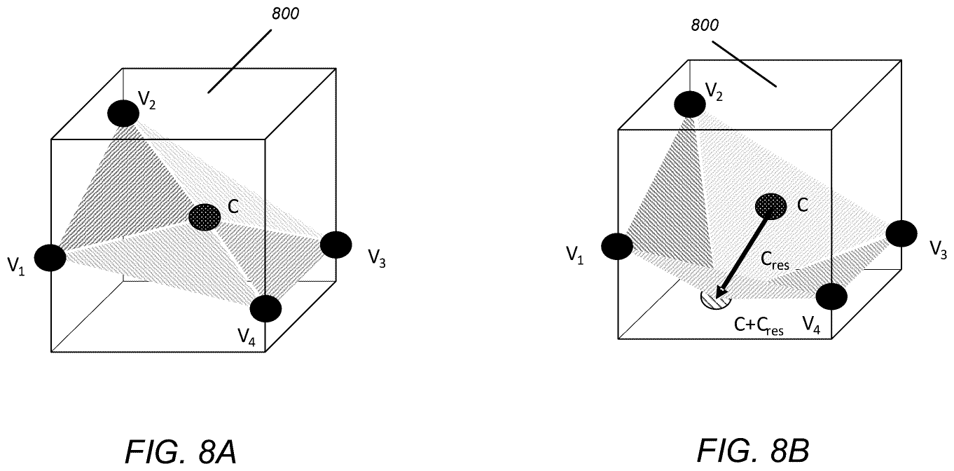

FIG. 8A shows an example cuboid 800 (e.g., a cube) corresponding to a TriSoup node. A cuboid 800 may correspond to a TriSoup node with a number K of TriSoup vertices Vₖ. Within cuboid 800, TriSoup triangles may be constructed from the TriSoup vertices Vₖ. TriSoup triangles may be constructed from the TriSoup vertices Vₖ, for example, if at least three (K≥3) TriSoup vertices are present on the TriSoup edges of cuboid 800. For example, with respect to FIG. 8A, four TriSoup vertices may be present and TriSoup triangles may be constructed. The TriSoup triangles may be constructed around the centroid vertex C defined as the mean of the TriSoup vertices Vₖ. A dominant direction may be determined, then vertices Vₖ may be ordered by turning around this direction, and the following K TriSoup triangles (listed as triples of vertices) may be constructed: V₁V₂C, V₂V₃C, . . . , V_{K}V₁C. The dominant direction may be chosen among the three directions respectively parallel to the axes of the 3D space to increase or maximize the 2D surface of the triangles, for example, if the triangles are projected along the dominant direction. By doing so, the dominant direction may be somewhat perpendicular to a local surface defined by the points of the point cloud belonging to the TriSoup node.

FIG. 8B shows an example refinement to the TriSoup model. The TriSoup model may be refined by coding a centroid residual value. A centroid residual vector Cᵣₑₛ may be coded into the bitstream. A centroid residual vector Cᵣₑₛ may be coded into the bitstream, for example, to use C+Cᵣₑₛ instead of C as a pivoting vertex for the triangles. By using C+Cᵣₑₛ as the pivoting vertex for the triangles, the vertex C+Cᵣₑₛ may be closer to the points of the point cloud than the centroid C, the reconstruction error may be lowered, leading to lower distortion at the cost of a small increase in bitrate needed for coding Cᵣₑₛ.

The reconstruction of a decoded point cloud from a set of TriSoup triangles may be referred to as “voxelization” and may be performed, for example, by ray tracing or rasterization, for each triangle individually before duplicate voxels from the voxelized triangles are removed.

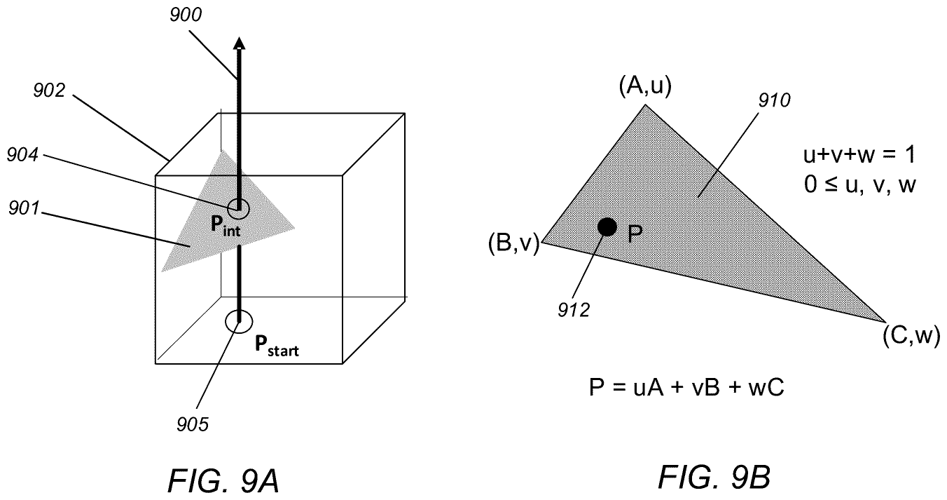

FIG. 9A shows an example of voxelization using ray tracing. Ray-triangle intersection algorithms, such as the Möller-Trumbore algorithm, may take advantage of launching rays, for example, to determine whether rays intersect with TriSoup triangles and if so, at what points of the TriSoup triangles. Rays may be launched from integral coordinates that correspond to the centers of voxels. As shown in FIG. 9A, rays, for example, ray 900 may be launched substantially parallel to one of the three coordinate axes of the 3D space, starting from integral coordinates (sometimes referred to as integer coordinates) such as an origin point 905 (shown as origin or starting point Pₛₜₐᵣₜ in FIG. 9A).

An intersection point 904 (shown as Pᵢₙₜ in FIG. 9A), if any, between ray 900 and a TriSoup triangle 901 belonging to a cube 902, corresponding to a TriSoup node, may be rounded (or, e.g., quantized) to obtain a decoded point corresponding to a voxel. A ray, for example, launched substantially parallel to a coordinate axis in 3D space, may intersect a TriSoup triangle. The ray may intersect the TriSoup triangle, for example, if and only if the projection, along the ray direction, of the center of a voxel belongs to the TriSoup triangle. In other words, the ray may be determined to intersect the TriSoup triangle if the point of intersection corresponds to the center of the voxel. This intersection may be determined, for example, by using a ray-triangle intersection algorithm (e.g., tracing or ray casting technique) such as the Möller-Trumbore algorithm to generate voxels representing the triangle.

Ray tracing techniques such as the Möller-Trumbore algorithm are based on generating, with respect to a triangle, barycentric coordinates of points of intersection between rays and a plane of the triangle. Then, points of the triangle may be determined from the barycentric coordinates.

FIG. 9B shows an example of voxelization using barycentric coordinates. More particularly, FIG. 9B shows an example of voxelization using barycentric coordinates (u, v, w) of a point 912 (P) relative to a TriSoup triangle 910 having vertices labeled A, B, and C in the 3D space. Point 912 may be determined as an intersection between a ray and a plane of TriSoup triangle 910 (e.g., containing or passing through the three vertices A, B, and C of TriSoup triangle 910). The ray may be launched, for example, substantially parallel to one of the three coordinate axes in 3D space. In some examples, this intersection point 912 may be uniquely represented as a sum of the three vertices of TriSoup triangle 910:

P=uA+vB+wC

under the condition u+v+w=1. Therefore, any point P of the plane (containing TriSoup triangle 910) has unique coordinates (u, v, w) in the barycentric coordinate system. A point with barycentric coordinates (u, v, w) may include an ordered triple of numbers u, v, and w. A point with barycentric coordinates (u, v, w) that sum to 1 (e.g., u+v+w=1) may be referred to as homogeneous barycentric coordinates and/or normalized barycentric coordinates. The barycentric coordinates of the intersection point with respect to TriSoup triangle 910 may be determined using algorithms, for example, the Möller-Trumbore algorithm.

By converting points with Cartesian coordinates in 3D space to homogeneous barycentric coordinates, the three vertices A, B, C of TriSoup triangle 910 may comprise respective barycentric coordinates A(1,0,0), B(0,1,0) and C(0,0,1). The convex hull (e.g., the TriSoup triangle 910) of the three vertices A, B, and C may be equal to the set of all points such that the barycentric coordinates u, v, and w are each greater than or equal to zero:

0≤u, v, w

Therefore, the intersection point may be determined to belong to TriSoup triangle 910, for example, based on the intersection point having barycentric coordinates with an ordered triple of values that are each greater than or equal to zero. Relatedly, if at least one of barycentric coordinates (i.e., one of u, v, or w) is negative or less than 0, then the intersection point may be determined to not belong to TriSoup triangle because it will be on the plane, but not on an edge or within the TriSoup triangle. A point determined to belong to TriSoup triangle 910 may be the ray intersecting TriSoup triangle 910 (e.g., within or at an edge of TriSoup triangle 910).

In the Möller-Trumbore algorithm, an intersection point of a ray with the plane to which a TriSoup triangle belongs may be determined based on computing, for the intersection point, the barycentric coordinates values of u, v, and w. The intersection point may be determined to be in the TriSoup triangle (e.g., on an edge of or within the TriSoup triangle), for example, based on verifying that each of the barycentric coordinates u, v, and w is greater or equal to 0 (e.g., 0≤u, v, w). Otherwise, the intersection point may be determined as being outside of the TriSoup triangle.

Presence flags (sₖ) and positions (pₖ) of TriSoup vertices on TriSoup edges can be efficiently entropy coded using neighboring information of neighboring (e.g., already-coded) TriSoup edges (e.g., already-coded flags and positions of TriSoup vertices) and the occupancy of cuboids neighboring the TriSoup edges. Specifically, a presence flag (sₖ) and, if the presence flag (sₖ) indicates the presence of a vertex, a position (pₖ) of the vertex along a current TriSoup edge may be entropy coded based on already-coded presence flags and positions (of present TriSoup vertices) of TriSoup edges, for example, that neighbor the current TriSoup edge. A presence flag (sₖ) and, if the presence flag (sₖ) indicates the presence of a vertex, a position (pₖ) on (e.g., indicating a position of the vertex along) a current TriSoup edge may be additionally or alternatively entropy coded based on occupancies of cuboids, for example, that neighbor the current TriSoup edge. The presence flag (sₖ) and position (pₖ) may be individually or collectively referred to as vertex information. Similar to the entropy coding of the occupancy bits of the occupancy tree, a configuration βTS for a neighborhood (also referred to as a neighborhood configuration βTS) of a current TriSoup edge may be obtained and dynamically reduced into a reduced configuration βTS′=DRn(βTS), for example, by using a dynamic OBUF scheme for TriSoup. A context index LUT[βTS′] may be obtained from the OBUF LUT and at least a part of the vertex information of the current TriSoup edge may be entropy coded, for example, using the context (also referred to as probability model or entropy coder) pointed to by the context index.

The TriSoup vertex position (pₖ) (if present) along its TriSoup edge may be binarized, for example, for use of a binary entropy coder to entropy code at least part of the vertex information of the current TriSoup edge. A number (e.g., quantity) of bits N_{b} may be set for the quantization of the TriSoup vertex position (pₖ) along the TriSoup edge of length N that is uniformly divided into 2^{Nb} quantization intervals. By doing so, the TriSoup vertex position (pₖ) may be represented by N_{b} bits (pₖ^{j}, j=1, . . . , N_{b}) that may be individually coded by the dynamic OBUF scheme as well as the bit corresponding to the presence flag (sₖ). The neighborhood configuration β_{TS}, the OBUF reduction function DRⁿ, and thus, the context index may depend on the nature/characteristic/property of the coded bit (presence flag (sₖ), highest position bit (pₖ¹), second highest position bit (pₖ²), etc.). There may be several dynamic OBUF schemes implemented, for example, with each dedicated to a specific bit of information (presence flag (sₖ) or position bit (pₖ^{j})) of the vertex information.

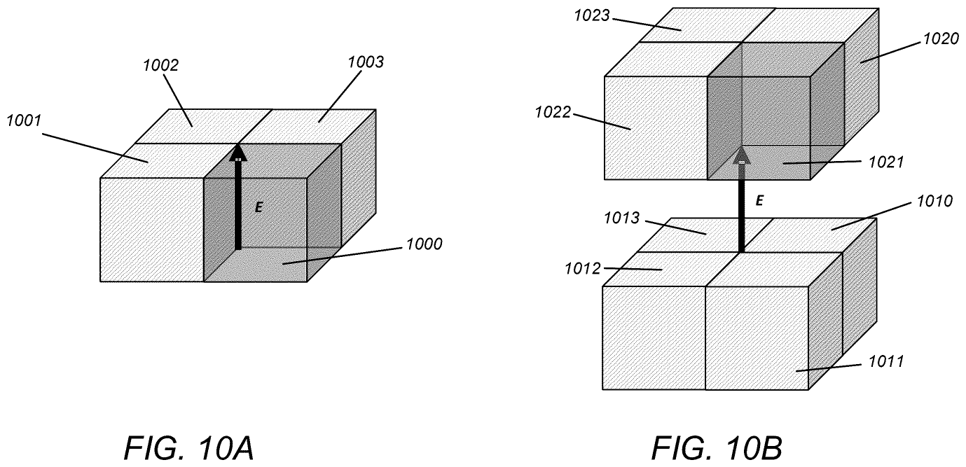

FIG. 10A and FIG. 10B show cuboids (e.g., cuboids 1000-1003 in FIG. 10A, cuboids 1010-1013, and cuboids 1020-1023 in FIG. 10B) with volumes that intersect a current TriSoup edge (e.g., a current TriSoup E) being entropy coded. The current TriSoup edge E is an edge of cuboids 1000-1003. The start point of the current TriSoup edge E intersects cuboids 1010-1013. The end point of the current TriSoup edge E intersects cuboids 1020-1023. The occupancy bits of one or more of the 12 cuboids 1000-1003, 1010-1013, and 1020-1023 may be used to determine the neighborhood configuration β_{TS} for the current TriSoup edge E. There may be, for example, up to 12 bits of neighborhood occupancy information corresponding to the 12 cuboids.

TriSoup edges may be oriented from a start point to an end point following the orientation of one of the three axes of the 3D space they are parallel to. A global ordering of the TriSoup edges may be defined as the lexicographic order over the couple (e.g., start point, end point). Vertex information related to the TriSoup edges may be coded following the TriSoup edge ordering. A causal neighborhood of a current TriSoup edge may be obtained from the neighboring already-coded TriSoup edges of the current TriSoup edge.

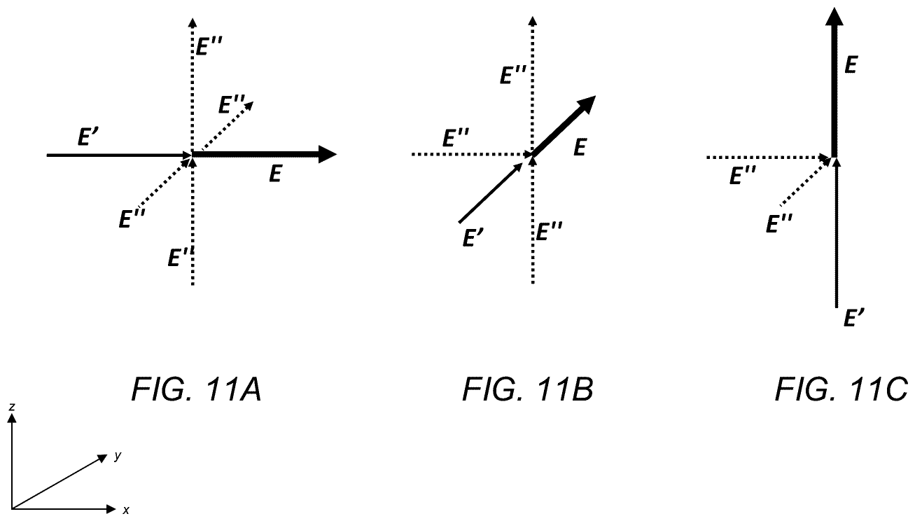

FIG. 11A, FIG. 11B, and FIG. 11C show TriSoup edges (E′ and E″) that may be used to entropy code a current edge E. As described herein, coding the current edge E may comprise coding the presence flag (sₖ) and position (pₖ), for example, of a TriSoup vertex (Vₖ) of the current TriSoup edge (e.g., E, k-th edge). The coded (e.g., already-coded) vertex presence flag (s_{k′}) and vertex position (p_{k′}), for example, associated with the TriSoup edges (e.g., k′-th edges) may belong to the causal neighborhood of the current TriSoup edge E. These five TriSoup edges may include:
the edge E′ parallel to the current TriSoup edge E and having an end point equal to the start point of the current TriSoup edge E, and
the four edges E'′ perpendicular to the current TriSoup edge E and having a start or end point equal to the start point of the current TriSoup edge E.
   Depending on the direction of the current TriSoup edge E, either two (FIG. 11C for direction z), three (FIG. 11B for direction y), or four (FIG. 11A for direction x) of the four perpendicular TriSoup edges may have been already coded and their vertex information may be used to construct the neighborhood configuration β_{TS} for the current TriSoup edge E. The TriSoup edge E′ may have already been coded for each direction of the current TriSoup edge E and its vertex information may be used to construct the neighborhood configuration β_{TS} for the current TriSoup edge E independent of its direction.

As described herein, the neighborhood configuration β_{TS} for a current TriSoup edge E may be obtained from one or more occupancy bits of cuboids and from the vertex information of neighboring already-coded TriSoup edges. The neighborhood configuration β_{TS} for the current TriSoup edge E may be obtained from one or more of the 12 occupancy bits of the 12 cuboids shown in FIG. 10A and FIG. 10B and from the vertex information (e.g., vertex presence (s_{k′}) and position (p_{k′})) of the at most five neighboring already-coded TriSoup edges (E′ and E″) shown in FIGS. 11A, 11B, and 11C.

Performance may be improved by using inter frame prediction, for example, in video compression. Bitrates needed to compress inter frames may be typically one to two orders of magnitude lower than bitrates of intra frames that, by definition, do not use inter frame prediction. Point cloud data may behave differently because the 3D geometry is coded, unlike video coding where typically only the attributes (e.g., colors) are coded after projection of the 3D geometry onto a 2D plane (e.g., a camera sensor). Even if 2D-projected attributes are expected to temporally have a higher correlation than their underlying 3D geometry, it may be expected that inter frame prediction between 3D point clouds may provide improved compression capability than intra frame prediction alone within a point cloud. The octree may benefit from inter frame prediction and geometry compression gains.

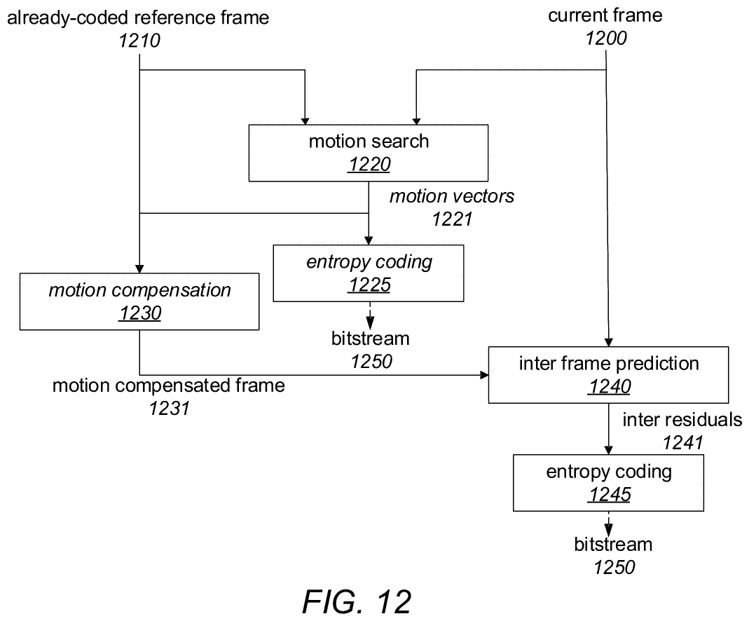

FIG. 12 shows an example encoding method. One or more steps of FIG. 12 may be performed by an encoder and/or a decoder (e.g., the encoder 114 and/or decoder 120 in FIG. 1), an example computer system 2500 in FIG. 25, and/or an example computing device 2630 in FIG. 26. A general framework of inter frame prediction for 3D point clouds may be similar to the one of video compression for the coding (e.g., encoding) process as described herein with respect to FIG. 12. A current frame 1200 (e.g., image or point cloud) may be coded based on an already-coded reference frame 1210 (e.g., image or point cloud). A motion search 1220 may be performed from the already-coded reference frame 1210 toward the current frame 1200, for example, to obtain motion vectors 1221. The motion vectors 1221 may represent a motion flow between the already-coded reference frame 1210 and the current frame 1200.

Motion vectors may be 2-component (e.g., 2D) vectors that may represent a motion from reference blocks of pixels to current blocks of pixels, for example, in at least some video compression. Motion vectors may be 3-component (e.g., 3D) vectors that may represent a motion from reference sets of 3D points to current sets of 3D points, for example, in at least some point cloud compression. The motion vectors 1221 may be entropy-coded (at step 1225, as shown in FIG. 12) into a bitstream 1250. The reference frame 1210 may be motion-compensated (at step 1230, as shown in FIG. 12), for example, to obtain a motion compensated-frame 1231. Motion compensation may involve moving the pixels of the reference image (respectively point cloud), for example, according to the 2D motion vectors, and/or moving the points of the reference point cloud according to the 3D motion vectors. The obtained motion compensated frame 1231 may be “closer” to the current frame 1200 than the reference frame 1210. A The obtained motion compensated frame 1231 may be closer to the current frame 1200 than the reference frame 1210, for example, in that the color difference (and/or point distance) between the motion compensated frame 1231 and the current frame 1200 may be smaller than between the reference frame 1210 and the current frame 1200. The obtained motion compensated frame 1231 may be closer to the current frame 1200 than the reference frame 1210, for example, the color difference and/or point distance between the motion compensated frame 1231 and the current frame 1200 may be, on average, smaller than that between the reference frame 1210 and the current frame 1200. At step 1240, inter frame prediction may be performed, for example, to obtain inter residual(s) 1241. The inter residual(s) 1241 may be entropy coded (at step 1245, as shown in FIG. 12) into a bitstream 1250. The inter residual(s) 1241 may carry more compressible information than the current frame 1200 or a current frame that has undergone an intra prediction process. The entropy coding 1245 may be more efficient for obtaining a bitstream 1250 with reduced size compared to a bitstream obtained by coding the current frame 1200 that may have not benefited from inter frame prediction.

As described herein, a current occupancy bit of an octree may be coded by an entropy coder. The entropy coder may be selected by the output of a dynamic OBUF Look-Up Table (LUT) of coder indices that may use a neighborhood configuration β as input. The neighborhood configuration β may be constructed, for example, based on already-coded occupancy bits associated with neighboring volumes (e.g., cuboids) relative to the current volume (e.g., cuboid). The current volume may be associated with the current node whose occupancy may be signaled by the current occupancy bit. The construction of the neighborhood configuration β may be extended, for example, by using inter frame information. An inter predictor occupancy bit may be defined for a current occupancy bit as a bit representative of the presence of at least one point of a motion compensated point cloud within the current volume. A strong correlation between the current occupancy bit and the inter predictor occupancy bit may exist, for example, if motion compensation is efficient, because the current compensated point cloud and motion compensated point clouds may be close to each other. Using the inter predictor occupancy bit as a bit of the neighborhood configuration β may lead to better compression performance of the octree (e.g., dividing the size of the octree bitstream by a factor two).

Inter residuals (e.g., the inter residuals 1241) may be constructed as a difference of colors, pixel per pixel, between a current block of pixels belonging to the current frame (e.g., image) and a co-located compensated block of pixels belonging to the motion compensated frame (e.g., image), for example, in video coding. The inter residuals (e.g., the inter residuals 1241) may be arrays of color differences that may have a small magnitude and thus may be efficiently compressed.

There may be no such concept as the difference between two sets of points. The concept of an inter residual may not be straightforwardly generalized to point clouds, for example, in point cloud compression. For prediction of an octree that may represent a point cloud, the concept of inter residual may be replaced by conditional entropy coding, where conditional information for performing conditional entropy coding may be constructed, for example, based on a motion compensated point cloud. This approach may be extended to the framework of dynamic Optimal Binary Coders with Update on the Fly (OBUF).

A motion field between octrees may comprise 3D motion vectors associated with 3D prediction units. The 3D prediction units may have volumes embedded into the volumes (e.g., cuboids) associated with nodes of the octree. A motion compensation may be performed volume per volume (e.g., per cuboid), for example, based on the 3D motion vectors to obtain a motion compensated point cloud in one or more current volumes. An inter predictor occupancy bit may be obtained, for example, based on the presence of at least one point of the motion compensated point cloud.

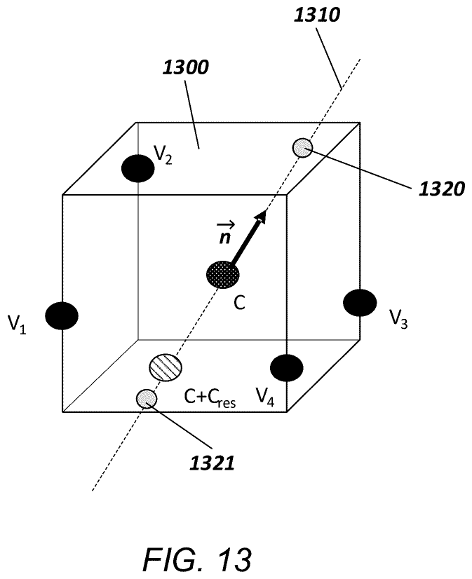

As described herein, FIG. 8B shows an example of coding a centroid vector Cᵣₑₛ into the bitstream to enable use of an adjusted centroid C+Cᵣₑₛ to reduce reconstruction error and reduce visual distortion. FIG. 13 shows an example of coding a centroid residual vector. FIG. 13 shows a more detailed example of coding a centroid residual vector Cᵣₑₛ in/from the bitstream such that an adjusted centroid C+Cᵣₑₛ may be used instead of centroid C for generating TriSoup triangles of a cuboid 1300 (e.g., corresponding to a TriSoup node) corresponding to a portion of a point cloud. The triangles may be generated, for example, based on adjusted centroid C+Cᵣₑₛ and adjacent pairs of vertices of an ordering of the vertices V₁-V₄. The ordering of the vertices may be determined, for example, as described herein with respect to FIG. 8A. As described herein, the TriSoup triangles of the cuboid may be voxelized at the decoder, for example, to generate voxels representing (or modeling) the portion, of the point cloud, corresponding to the cuboid. A unit vector n (e.g., also referred to as a normalized vector) may be determined as a normalized mean vector of normal vectors to the triangles (V₁V₂C, V₂V₃C, . . . , V_{K}V₁C) constructed by centroid C and pairs of the vertices of the cuboid, for example, by pivoting around the centroid C (e.g., as described herein with respect to FIG. 8A). The unit vector n may be determined as the normalized vector, for example, based on a mean of cross-products representing areas of the triangles (\vec{V₁C}×\vec{V₂C}+\vec{V₂C}×\vec{V₃C}+ . . . +\vec{V_{K}C}×\vec{V₁C})/K. The unit vector \vec{n} may be determined, for example, by dividing the mean vector (n) by the norm (or length) of the mean vector (i.e., \vec{n}=n/∥n∥).

A value resulting from each cross product may be equal to an area of a parallelogram formed by the two vectors in the cross product. The value may be representative of an area of a triangle formed by the two vectors because the area of the triangle is equal to half of the value. Since the vector n indicates a direction of the triangles (e.g., TriSoup triangles) representing (e.g., modeling) the portion of the point cloud, the vector n may be indicative of the direction normal to a local surface representative of the portion of the point cloud. A one-component residual value αᵣₑₛ along the line (C, \vec{n}) (1310) may be coded instead of a residual vector, for example, to maximize the effect of the centroid residual and minimize its coding cost.

Cᵣₑₛ=αᵣₑₛ\vec{n}

The residual value αᵣₑₛ may be determined by the encoder, for example, as the intersection between the current point cloud and the line (C, \vec{n}), which may be along the same direction of the normalized vector \vec{n}. A set of points, of the portion of the point cloud, closest (e.g., within a threshold distance, a threshold quantity/number of points) to the line may be determined. The set of points may be projected on the line and the residual value αᵣₑₛ may be determined as the mean component along the line of the projected points. The mean may be determined as a weighted mean whose weights depend on the distance of the set of points from the line. A point from the set closer to the line may have a higher weight than another point from the set farther from the line.

The residual value αᵣₑₛ may be quantized. The residual value αᵣₑₛ may be quantized by a uniform quantization function, for example, having quantization step similar to the quantization precision of the TriSoup vertices Vₖ. By doing so, the quantization error may be maintained to be uniform over all vertices Vₖ and C+Cᵣₑₛ such that the local surface may be uniformly approximated.

Also or alternatively, the residual value αᵣₑₛ may be binarized and coded (e.g., entropy coded) into the bitstream. The residual value αᵣₑₛ may be binarized and coded (e.g., entropy coded) into the bitstream, for example, by using a unary-based coding scheme. Also or alternatively, the residual value αᵣₑₛ may be coded using a set of flags. A flag f₀ may be coded, for example, to indicate if the residual value αᵣₑₛ is equal to zero. If the flag f₀ indicates the residual value αᵣₑₛ is zero, no further syntax elements may be needed. If the flag f₀ indicates the residual value αᵣₑₛ is not zero, a sign bit indicating a sign may be coded and the residual magnitude |αᵣₑₛ|−1 may be coded using an entropy code. The residual magnitude may be coded using a unary coding scheme, for example, that may code successive flags fᵢ (i≥1) indicating if the residual value magnitude |αᵣₑₛ| is equal to ‘i’. A binary entropy coder may binarize the residual value αᵣₑₛ into the flags fᵢ (i≥0) and entropy code the binarized residual value as well as the sign bit.

Compression of the residual value αᵣₑₛ may be improved by determining bounds, for example, as shown in FIG. 13. As shown, the line (C, \vec{n}) 1310 may intersect the current cuboid 1300 (corresponding to a TriSoup node) at two bounding points 1320 and 1321 and the encoder may impose that the adjusted centroid vertex C+Cᵣₑₛ may be located between the two bounding points 1320 and 1321. These bounding points 1320 and 1321 may also bound the residual value αᵣₑₛ (which may be quantized) as belonging to an integral interval [m, M] where m≤0≤M. By doing so, some bits of the binarized residual value αᵣₑₛ may be inferred. If m=M=0, for example, then residual value αᵣₑₛ may necessarily be equal to zero. In another example, if m=0<M, then the sign bit may necessarily be positive. If the residual value αᵣₑₛ is not equal to zero and its sign is known, its magnitude |αᵣₑₛ |may be determined to be bounded by either |m| or M such that the magnitude may be coded by a truncated unary coding scheme that may infer the value of the last of successive flags fᵢ (i≥1).

The binary entropy coder used to code the binarized residual value αᵣₑₛ may be a context-adaptive binary arithmetic coder (CABAC), for example, such that the probability model (e.g., also referred to as a context or an entropy coder) used to code at least one bit (e.g., fᵢ or sign bit) of the binarized residual value αᵣₑₛ may be updated depending on precedingly coded bits. The probability model of the binary entropy coder may be determined, for example, based on contextual information such as the values of the bounds m and M, the position of vertices Vₖ, or the size of the cuboid. The selection of the probability model (e.g.,, also referred equivalently as an entropy coder or context) may be performed by a scheme (e.g., a dynamic OBUF scheme) with the contextual information described herein as inputs.

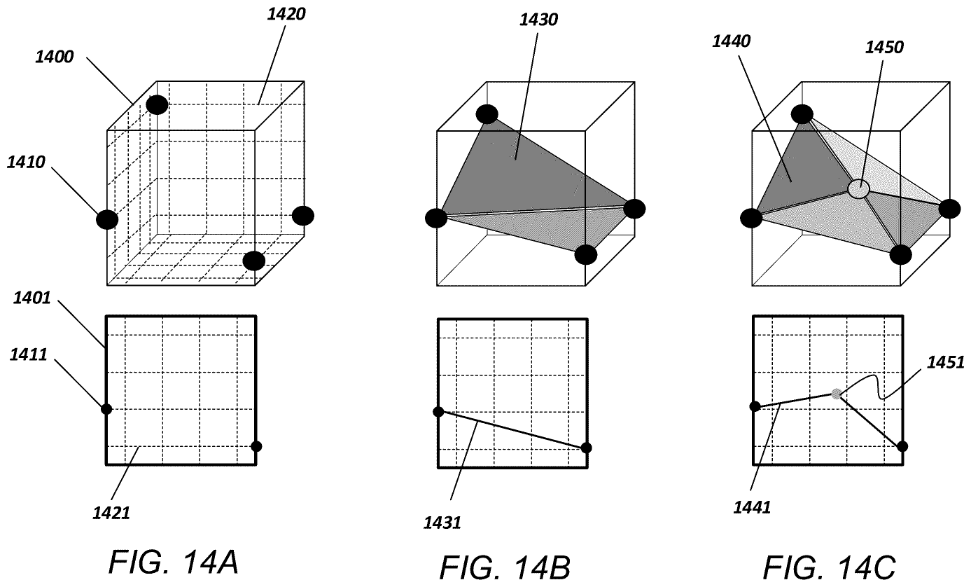

FIG. 14A, FIG. 14B, FIG. 14C show examples of the 3D TriSoup method represented in 2D. For the sake of clarity and ease of depiction and description, 2D depictions are provided in FIGS. 14-22 to illustratively represent a TriSoup method of coding 3D scenes and/or 3D objects represented by a point cloud in 3D space. Examples of such depictions are shown in FIGS. 14A-14C. FIG. 14A shows, in 3D, a cuboid 1400 (e.g., corresponding to and indicated by a TriSoup node) that may be illustratively represented in 2D by a square 1401. Similarly, TriSoup vertices 1410 located on the edges of cuboid 1400 may be illustratively represented in 2D by TriSoup vertices 1411 on the edges of square 1401. Similarly, a 3D quantization grid 1420 of vertices and/or points of the point cloud may be illustratively represented in 2D by a 2D quantization grid 1421 in square 1401. FIG. 14B shows TriSoup triangles 1430, in 3D, constructed from TriSoup vertices as described herein with reference to FIGS. 7, 8, and 13, that may be illustratively represented in 2D by lines 1431 between 2D TriSoup vertices. FIG. 14C shows TriSoup triangles 1440, in 3D, constructed by pivoting around a 3D centroid vertex 1450, as described herein, for example, with reference to FIG. 8A. 3D centroid vertex 1450 may be illustratively represented in 2D by a point 1451 belonging to the square illustratively representing the cuboid. Similarly, TriSoup triangles 1440 may be illustratively represented in 2D by lines 1441 between 2D TriSoup vertices and 2D centroid vertices such as point 1451.

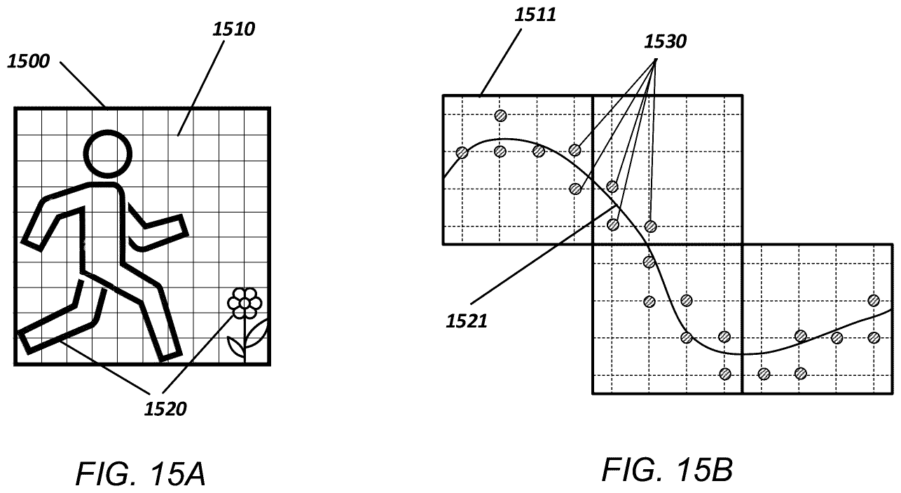

FIG. 15A shows an example of a point cloud contained in a bounding box. More specifically, FIG. 15A shows an original point cloud representing a three-dimensional (3D) scene or objects 1520 encompassed by (e.g., contained in) a bounding box 1500. Bounding box 1500 may comprise a cuboid large enough to fully contain (and/or encompass) the 3D scene, for example, including one or more objects 1520. Bounding box 1500 may be split, for example, by using a recursive splitting process. The recursive splitting process may be an octree-based process described herein, for example, with respect to FIG. 3. Bounding box 1500 may be split, for example, into a set of cuboids (e.g., corresponding to and indicated by TriSoup nodes) that may have various sizes. FIG. 4 shows an example of the octree indicating a plurality of cuboids, of different sizes, representing the point cloud (e.g., representing occupancy of points of the point cloud within volumes of the cuboids). The 2D illustration in FIG. 15A shows the set of cuboids in bounding box 1500 being aligned to a 3D grid 1510 of cuboids. As described herein, the set of cuboids (e.g., TriSoup nodes) containing portions of the point cloud may be coded to represent the point cloud. In some examples, the grid spacing of 3D grid 1510 may be equal to a maximum size of the set of cuboids. The 3D grid 1510 may be a grid of cuboids corresponding to a maximum sized cuboid of the set of cuboids (e.g., TriSoup nodes).

FIG. 15B shows example portions of the point cloud of cuboids in the bounding box of FIG. 15A. More specifically, FIG. 15B shows points 1530 of the original point cloud belonging to (e.g., contained in) occupied cuboids 1511 corresponding to TriSoup nodes. Points 1530 may be quantized to certain positions in the quantization grid illustratively representing a 3D quantization grid for the point cloud. Points 1530 may be locally represented by a curve 1521 in 2D, for example, to illustratively represent the local 3D surface of the portion of the point cloud belonging to (e.g., contained in or represented by) cuboids 1511. Points 1530 may be locally represented by a curve 1521 in 2D, for example, since the point cloud represents a 3D scene and/or one or more 3D objects that may have continuous dense surfaces.

In order to further simplify the figures and for clarity of description, point clouds will be illustratively represented by their local surfaces/curves hereinafter instead of drawing the many points of the point cloud. It should be noted that such a representation is not part of the TriSoup process, which may determine TriSoup vertices, centroid vertices, and TriSoup triangles directly from points 1530 of the original point cloud without using an intermediate local modelling of points such as by a surface.

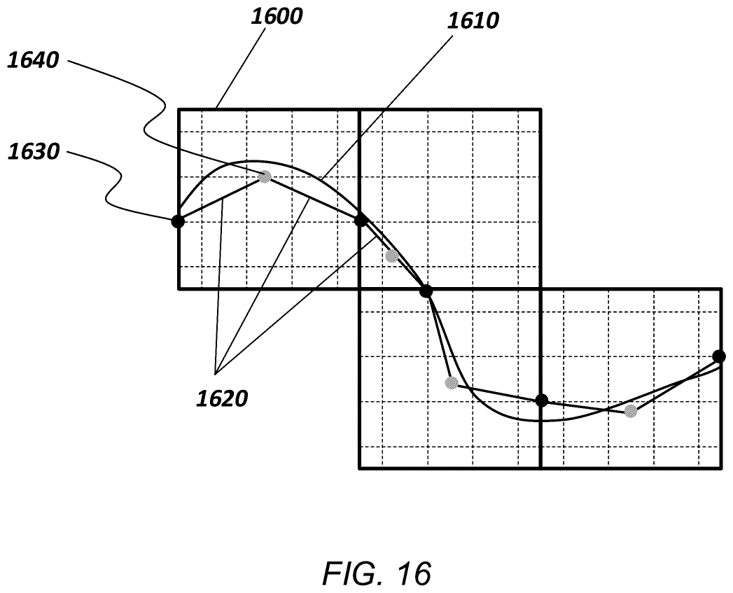

FIG. 16 shows an example of TriSoup modeling of point cloud using simplified 2D representations. More specifically, FIG. 16 shows an example of TriSoup triangles 1620 generated to represent (e.g., modeling or approximating) a portion 1610, of an original point cloud, belonging to (e.g., being contained within) occupied cuboids 1600. As described herein, for simplification of illustration and description, portion 1610 is shown in 2D as a curve to illustratively represent a local 3D surface representing the points (not shown in FIG. 16) of the original point cloud contained in cuboids 1600. TriSoup triangles 1620 may be constructed from TriSoup vertices 1630 and centroid vertices 1640, for example, determined from the points of portion 1610, as described herein, for example, with respect to FIG. 8A, FIG. 8B, and FIG. 13. In other words, the TriSoup triangles 1620 may represent a first-order interpolation of the local surface representative of the portion 1610 of the point cloud.

A dynamic point cloud may include a sequence of point clouds (e.g., also referred to as point cloud frames or frames in the present disclosure) that represent a dynamic scene, for example, in point cloud coding. The bounding box across the frames may change together with the 3D moving scene represented by the dynamic point cloud.

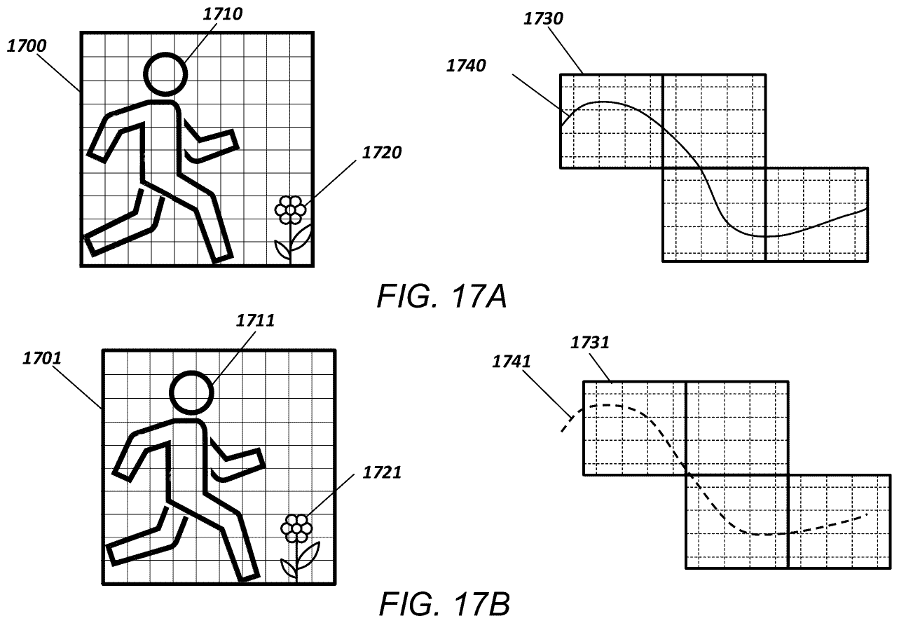

FIG. 17A and FIG. 17B show examples of two successive point clouds encompassed by respective bounding boxes. FIG. 17A shows an example of a first frame having a first bounding box 1700 containing (e.g., encompassing) the 3D scene or objects (e.g., object 1710 and 1720) located in the 3D space at the time instance of the first frame. FIG. 17B show an example of a second frame having a second bounding box 1701 containing (e.g., encompassing) the 3D scene or objects (e.g., object 1711 and/or object 1721) located in the 3D space at the time instance of the second frame. Object 1711 may be the same object as object 1710 at a different time instance. Similarly, object 1721 may be the same object as object 1720 at a different time instance. First bounding box 1700 and second bounding box 1701 may or may not be the same, for example, due to the motion of the scene or objects in 3D space. The grid of cuboids (e.g., corresponding to TriSoup nodes) associated with each of the bounding boxes 1700 and 1701 may move together with the respective bounding boxes 1700 and 1701.

A portion 1740 of the point cloud of the first frame may belong to (e.g., be contained or correspond to) some cuboids 1730 corresponding to TriSoup nodes. As shown in FIG. 17B, portion 1740 has moved to become a portion 1741 of the point cloud in the second frame. Portion 1741 may be represented by (e.g., contained within) cuboids 1731 corresponding to respective TriSoup nodes. The two sets of cuboids 1730 and 1731 (and corresponding sets of TriSoup nodes) may have moved relative to each other, for example, due to the change of first bounding box 1700 to second bounding box 1701.

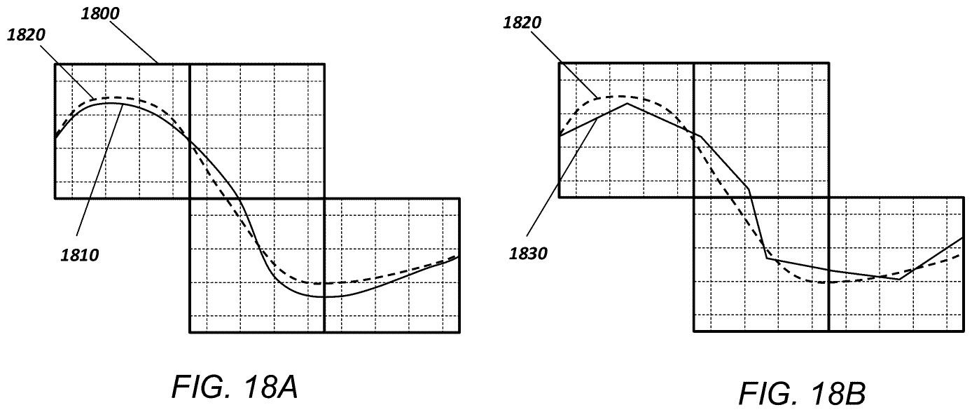

FIG. 18A and FIG. 18B show examples of motion compensation between two frames represented in 2D. More specifically, FIG. 18A and FIG. 18B show an example of motion compensation between two frames assuming, for example and for simplicity of the illustration and description, that the bounding box has not changed between the first and the second frame. As shown in FIG. 18A, a first portion 1810 of the point cloud of the first frame, belonging to a set of cuboids 1800 (e.g., indicated by respective TriSoup nodes), may move to become a second portion 1820 of the point cloud of the second frame following the first frame. The encoding process may determine a 3D motion field that may approximate the transformation (e.g., motion) of the first portion 1810 into the second portion 1820. The first frame may be coded using the TriSoup method, for example, such that first portion 1810 may be coded as a set of TriSoup triangles (e.g., voxelized TriSoup triangles) that may be displaced using the 3D motion field, for example, to obtain a motion compensated point cloud 1830 (illustratively represented in FIG. 18B as 2D TriSoup triangles), to predict the geometry of second portion 1820 of the second frame. The second portion 1820 may be coded, for example, based on motion compensated point cloud 1830, as described herein, for example, with reference to FIG. 12.

Inter-frame prediction of point cloud frames may be performed by predictively coding a point cloud in a second frame, for example, using a motion-compensated point cloud determined from the point cloud in a first frame that was previously coded, for example, as described herein with reference to FIG. 12. Implementing inter-frame prediction by a motion-compensated point cloud based on independently generated bounding boxes, that vary with the point cloud across time, may lead to poorly predicted TriSoup vertices and thus an increase in the bitrate used to code the TriSoup information.

Examples of the present disclosure relate to aligning bounding boxes and/or respective sets of cuboids across point cloud frames and/or with each other. Aligning the bounding boxes and/or respective set of cuboids as described herein may reduce inter-prediction error for portions (e.g., that are static or have little motion, or have relatively different motion as compared to other portions) of a point cloud (e.g., a dynamic point cloud). A first plurality of cuboids, for example, in a first bounding box may be determined to code a current point cloud. The first plurality of cuboids may be aligned with a three-dimensional (3D) grid. A second plurality of cuboids, for example, in a second bounding box (e.g., of a reference point cloud), may also be aligned with the 3D grid. Vertex information of the first plurality of cuboids may be coded, for example, based on previously-coded vertex information of the second plurality of cuboids.

Alignment of the first plurality of cuboid (e.g., in a current point cloud) and second plurality of cuboids (e.g., in a reference point cloud) may comprise setting a grid spacing of the 3D grid (e.g., to which the first and second plurality of cuboids are aligned) to a maximum size of respective sizes of the first plurality of cuboids. Also or alternatively, the grid spacing of the 3D grid may be set to a lowest common multiple of respective sizes of the first plurality of cuboids and/or the second plurality of cuboids. Additionally, the first and second bounding boxes may comprise bounding box axes. The bounding box axes may be substantially parallel with respective axes of the 3D grid. The origins of the first and second bounding boxes may be located at (e.g., set to) grid points of the 3D grid. The origins of the first and second bounding boxes may be located, for example, at integral coordinates of the 3D grid. Such alignment of bounding boxes may improve the accuracy of inter prediction of frames. Also or alternatively, such alignment of bounding boxes may result in reduced bitrate of elements (e.g., TriSoup vertices) coded based on inter prediction of frames.

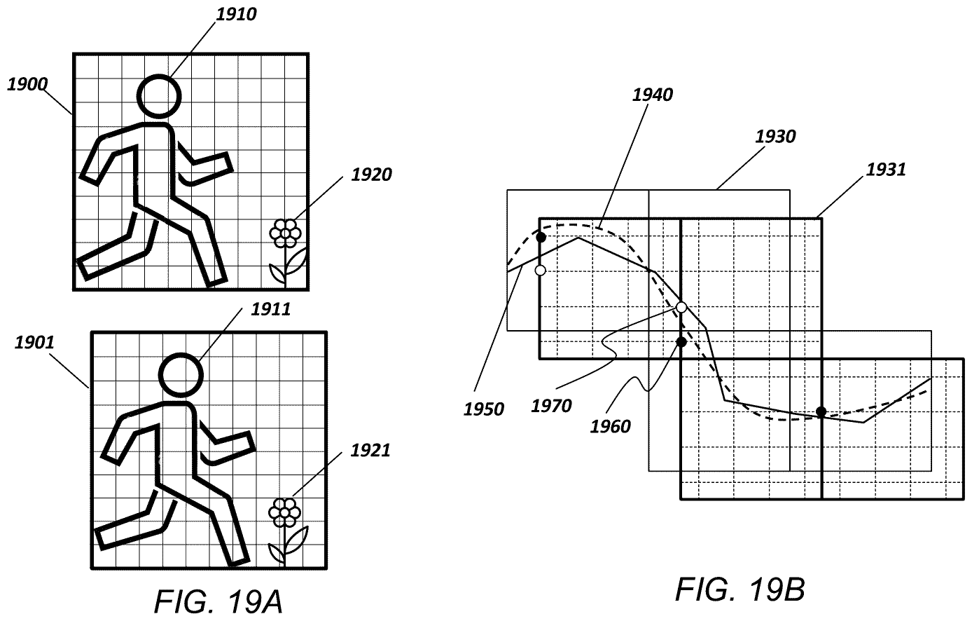

FIG. 19A and FIG. 19B show examples of reduced accuracy of inter prediction using motion compensation. More specifically, FIG. 19A and FIG. 19B show examples of reduced accuracy of inter prediction using motion compensation where cuboids of different frames are aligned to different 3D grids. FIG. 19A shows an example of a first frame having a first bounding box 1900 and a second frame having a second bounding box 1901 that has moved relative to first bounding box 1900 due to the displacement of objects, for example, from object 1910 to object 1911, or some portion of the 3D scene. Other objects or portions of the 3D scene (e.g., the flower shown in the first and second frames) may not have moved or may have marginally moved from object 1920 to object 1921. The 3D grid of cuboids (e.g., corresponding to TriSoup nodes) with which respective bounding boxes are aligned may be located differently relative to portions or objects of the 3D scene, for example, objects that have or have not moved. The 3D grid of cuboids may be located differently relative to portions or object of the 3D scene, for example, due to the change in bounding boxes.

FIG. 19B illustrates an example of an adverse effect on the quality of inter prediction of a static (and/or almost static) object due to the displacement or difference between 3D grids with which bounding boxes (and associated cuboids) are aligned. The 3D grid may be displaced, for example, from a first grid position 1930 of a first grid to a second grid position 1931 of a second grid for the first frame (e.g., corresponding to bounding box 1900) and the second frame (e.g., corresponding to bounding box 1901), respectively. In inter-frame coding, a portion 1940 of the point cloud of the second frame (e.g., corresponding to bounding box 1901) may be coded based on motion-compensated point cloud 1950 of first frame corresponding to bounding box 1900. The coding may be performed for cuboids (and, e.g., corresponding TriSoup nodes), for example, aligned with a grid at second grid position 1931. Interpolation of the first frame, corresponding to bounding box 1900, for example, by the TriSoup model may have been performed on cuboids (e.g., of corresponding TriSoup nodes) aligned with a first 3D grid at first grid position 1930. The error of interpolation may be maximum between points of interpolations, here, for example, TriSoup vertices and centroid vertices. The edges of the second grid may be located between edges of the first grid, for example, due to the displacement of the 3D grid of cuboids from the first grid position 1930 to the second grid position 1931, thus leading to positions of the TriSoup vertices 1960 (shown as black circles in FIG. 19B) of the second grid to fall in the zone of substantially maximum error of interpolation error of the first frame corresponding to bounding box 1900. Motion predicted TriSoup vertices 1970 (shown as white circles in FIG. 19B) may be relatively poor predictors of TriSoup vertices 1960 of the second frame (e.g., corresponding to bounding box 1901), and the quantity/number of bits required to code the TriSoup information may increase based on (e.g., as a result of, because of) the higher prediction error being coded into the bitstream. This problem resulting from bounding box displacement between frames may occur even without local motion. Edges of the cuboids (e.g., corresponding to TriSoup nodes) of the second frame (e.g., corresponding to bounding box 1901) may be, for example, in a region of high interpolation error of the first frame independent of a magnitude of the motion field.

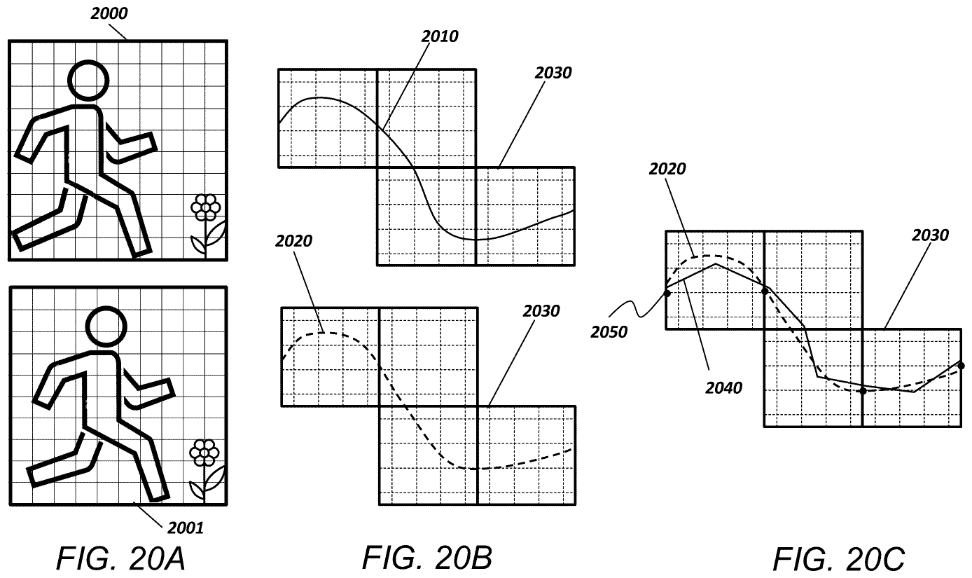

FIG. 20A, FIG. 20B, and FIG. 20C show examples of imposing grid alignment between frames. More specifically, FIG. 20A, FIG. 20B, and FIG. 20C, show an example of how imposing grid alignment between frames may increase the quality of inter prediction. First bounding box 2000 of a first frame and a second bounding box 2001 of a second frame may be the same despite motion of objects in the 3D scene, for example, as show in FIG. 20A. As shown for example in FIG. 20B, a first portion 2010 of the point cloud of the first frame (e.g., contained in bounding box 2000) may have moved an amount to become a second portion 2020 of the point cloud of the second frame (e.g., contained in bounding box 2001), with both portions 2010 and 2020 belonging to (e.g., being contained in) identical sets of cuboids 2030 (e.g., indicated by TriSoup nodes). As shown in FIG. 20C, first portion 2010 may be coded, for example, using the TriSoup method and then moved, according to a 3D motion field, to a motion-compensated point cloud 2040, which may approximate (e.g., in position) a second portion 2020. The prediction of TriSoup vertices 2050 of the second frame by motion-compensated point cloud 2040 may be more accurate, for example, due to aligning cuboids of both bounding boxes 2000 and 2001 to the same 3D grid (e.g., in this case, with the bounding boxes 2000 and 2001 being identical), which may reduce the quantity/number of bits needed to code the TriSoup information associated with vertices.

Bounding boxes and associated cuboids, for example, across point clouds TriSoup, may be aligned to the same 3D grid (e.g., also referred to as TriSoup grid alignment in the present disclosure) for point cloud frames in which a first frame may be used to predict a second frame. Grid alignment, to the 3D grid, of the first cuboids (e.g., corresponding to TriSoup nodes) of a first bounding box having different sizes may refer to alignment of the largest of the first cuboids (or of cuboids having sizes equal to the lowest common multiple of sizes of the first cuboids) to the 3D grid. In other words, the 3D grid may have a grid spacing equal to the maximum size of the first cuboids (or equal to the lowest common multiple of sizes of the first cuboids).

The 3D grid may be understood, mathematically, as a lattice (or a 3D grid of points) in 3D Euclidian space generated by three vectors, each of the vectors being parallel to an axis of the 3D space. Two grids may be considered aligned if they have the same generating vectors and if they have a common point. A bounding box may be aligned with a 3D grid, for example, based on the bounding box's axes (e.g., in the x, y, and z directions) being parallel to corresponding axes (e.g., in the x, y, and z directions) of the 3D grid, and the bounding box's origin being a grid point of the 3D grid (e.g., positioned at an integer coordinate of the 3D grid).

As described herein, aligning cuboids of different point clouds corresponding to different frames to the same 3D grid may increase accuracy of inter-predicted point clouds. In some examples, these point clouds for which bounding boxes and associated cuboids are aligned may be part of a sequence of point clouds, such as a sequence of point cloud frames constituting a Group of Pictures (GOP).

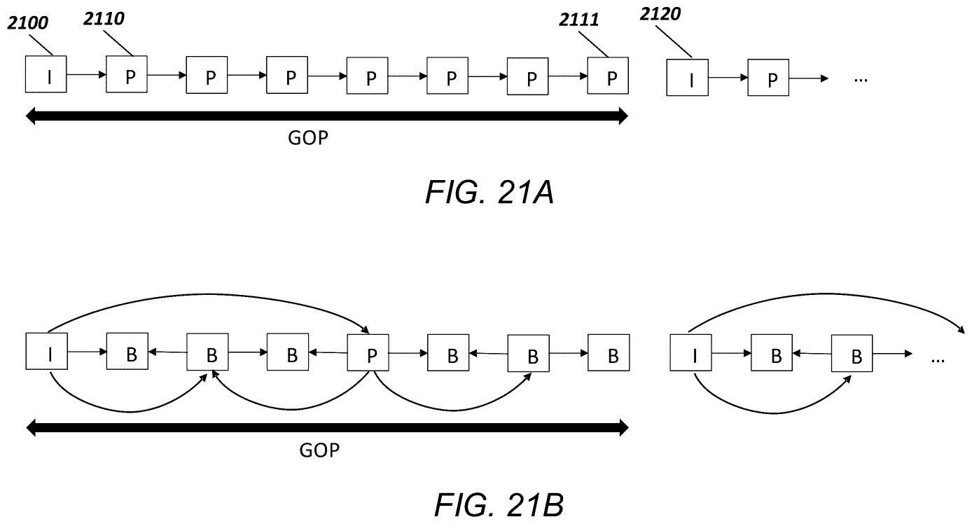

FIG. 21A and FIG. 21B show example structures of inter prediction between frames in a sequence of frames. More specifically, FIG. 21A shows a low-delay structure for coding point cloud frames starting from a first intra-frame I 2100. A second frame P 2110 may be inter predicted from first intra-frame I 2100. Successive frames P may be inter predicted from their preceding frame until a last inter frame P 2111 is coded. A new intra frame I 2120 may be coded, for example, without inter prediction. The new intra frame I 2120 may be coded, for example, after the last inter frame P 2111. A sequence of frames from first intra-frame I 2100 to the last inter frame P 2111 may constitute a GOP. GOPs may be coded successively and may be independently coded (e.g., encoded and/or decoded) starting from their initial intra frame.

FIG. 21B illustrates a random-access structure of a sequence of frames. For a random-access structure of a sequence of frames, some frames B may be bidirectionally predicted from both preceding and successive frames. Consequently, whereas coding order may be the same as viewing order of frames, for example, as shown in FIG. 21A, coding order for the sequence of frames may also be different from the viewing order, for example, as depicted in FIG. 21B. Nevertheless, the concept of GOP remains substantially similar and grid alignment, as described herein, may be similarly performed for cuboids (and/or corresponding bounding boxes) across frames within each GOP.

To ensure grid alignment of cuboids between multiple frames, for example, the sequence of frames shown in FIG. 21A and FIG. 21B, bounding boxes for frames may be set to be the same with the same origins in the 3D grid. This approach may be impractical for a long chain of predictions between frames because such an approach may comprise determining a common bounding box beforehand, for the multiple frames, to be large enough to contain the point clouds of all of the multiple frames. A GOP for a point cloud may correspond to a long length of time, for example, up to half a dozen seconds. Determining a common bounding box across multiple frames may comprise first processing each of the frames, which may increase latency of coding the frames. Accordingly, bounding box displacements may be coded instead of bounding box position, for example, to address the issues described herein.

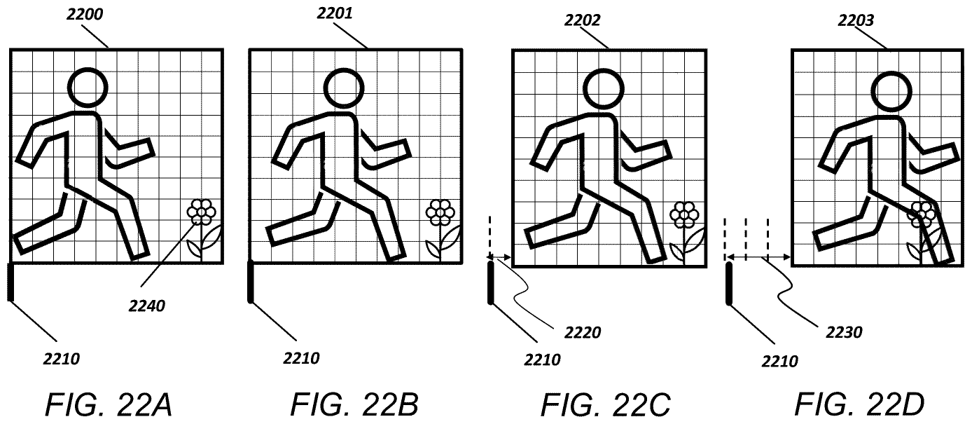

FIG. 22A, FIG. 22B, FIG. 22C, and FIG. 22D show examples of displacements of bounding boxes between frames. More specifically, FIG. 22A, FIG. 22B, FIG. 22C, and FIG. 22D together show an example of aligning different bounding boxes and corresponding cuboids across four frames (e.g., point cloud frames) to the same 3D grid. Instead of fixing a bounding box for multiple frames, grid alignment may be obtained despite a moving bounding box, that may change from frame to frame, for example, by constraining a displacement of positions of bounding boxes between frames (e.g., from a GOP sequence of frames). The displacement may indicate a multiple of grid spacing of the 3D grid. The displacement may include three values corresponding to displacement of the bounding box along the three axes (e.g., x-axis, y-axis, and z-axis) of the 3D grid. The grid spacing (e.g., in each of x, y, and/or z directions) may be equal to a largest size of cuboids of a point cloud. The grid spacing (e.g., in each of x, y, and/or z directions) may be equal to the lowest common multiple of sizes of the cuboids.

Each frame in FIGS. 22A-22D has a respective bounding box 2200-2203. The bounding boxes 2200-2203 may or may not be common to all frames. The position 2210 of the origin of bounding box 2200 of the first frame is depicted relative to each frame in FIGS. 22A-22D. As shown, example displacements 2220 and 2230 of bounding boxes 2202 and 2203, respectively, are relative to first bounding box 2200. Moreover, displacements 2220 and 2230 may each be equal to a multiple of the largest cuboid size or the lowest common multiple of cuboid sizes. Displacements 2220 and 2230 may comprise a multiple of a cuboid, for example, if all cuboid sizes are the same for all bounding boxes. By constraining and setting positions of bounding boxes through the use of such displacement, local invariance of the 3D grid, for example, for a static object 2240, may be maintained for all frames aligned to the 3D grid. Accordingly, such constraining and setting positions of bounding boxes may result in increased accuracy and reduced bitrate for inter prediction of frames.

Coding the displacement of bounding boxes instead of coding the bounding box positions may also reduce the quantity/number of bits of information to code the origins of bounding boxes across inter predicted frames. The displacement may indicate, for example, a multiple of the largest cuboid size (or the lowest common multiple of cuboid sizes). The displacement (d) of the bounding box may be coded to indicate a multiple (m) of a cuboid size(s), where d=m*s. With cuboid size ‘s’ being known, it may be advantageous to code the multiple ‘m’ instead of the displacement ‘d,’ as coding the multiple ‘m’ instead of displacement ‘d’ may comprise fewer bits of coding.

An origin of a bounding box may be coded into a bitstream for a first frame I of a sequence of frames (e.g., a GOP). But, displacements of bounding boxes may be coded relative to the bounding box of a precedingly coded frame, for example, for subsequent inter-predicted frames of the sequence of frames. For a relatively low-delay configuration (e.g., in which frames are coded in chronological order) (e.g., as shown in FIG. 21A), the displacement of the bounding box of a frame P may be coded relative the bounding box of the preceding frame I or P. For a random-access configuration (e.g., in which frames are coded other than in chronological order) (e.g., as shown in FIG. 21B), the displacement of the bounding box of a frame P or B may be coded relative to a closest already-coded frame I, Por B.

An indication (e.g., a flag or a syntax element of coding the bounding box) may be signaled to indicate that the bounding box of a current frame is equal to the bounding box of a preceding frame, for example, to reduce bits of bounding box coding. The encoder may encode and send (e.g., transmit) the indication that is received and decoded by the decoder. Similarly, the indication (e.g., a flag or a syntax element (e.g., align_slice_flag) associated with coding the bounding box) may be used to check and/or ensure that the alignment (e.g., the bounding box of a current frame is substantially aligned to the bounding box of a preceding frame and/or the bounding box of the a current frame is aligned to a 3D grid to which the bounding box of a preceding frame is also aligned) is in conformance with an alignment condition (e.g., a requirement, criterion, and/or condition to constrain the displacement of positions of bounding boxes between frames, as described herein). Thus, for example, the encoder may encode the indication and check for and/or confirm conformance with the alignment condition.

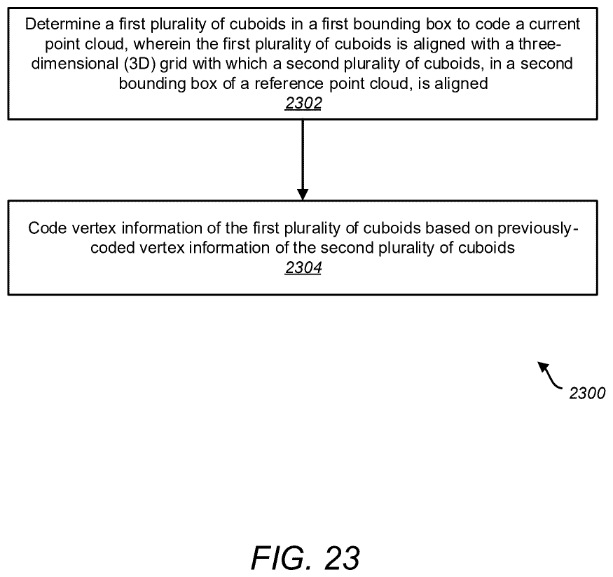

FIG. 23 shows an example method for TriSoup alignment between point clouds. More specifically, FIG. 23 shows a flowchart 2300 of example method steps for TriSoup alignment between point clouds. The method of flowchart 2300 may be performed and/or implemented, for example, by a decoder (e.g., decoder 120 in FIG. 1) and/or by an encoder (e.g., encoder 114 in FIG. 1). As described below, the decoder and/or encoder may perform reciprocal operations unless explicitly stated otherwise. Steps (e.g., blocks) of the example method of FIG. 23 may be omitted, performed in other orders, and/or otherwise modified, and/or one or more additional steps may be added.

At step 2302, a first plurality of cuboids in a first bounding box may be determined to code a current point cloud. The first plurality of cuboids may be aligned with a three-dimensional (3D) grid with which a second plurality of cuboids, in a second bounding box of a reference point cloud, is aligned. As described herein, for example, with respect to FIGS. 4, 15A, 15B, 20A, 20B, and 20C the first plurality of cuboids may have the same or different sizes. The 3D grid may be a grid of cuboids. Also or alternatively, the 3D grid may be a grid of 3D points. Also or alternatively, the 3D grid may comprise a grid spacing equal to a maximum size of the first plurality of cuboids. Also or alternatively, the 3D grid may comprise a grid spacing equal to a maximum size, of a plurality of respective sizes, of the first plurality of cuboids. Also or alternatively, the 3D grid may comprise a grid spacing equal to a lowest common multiple of a plurality of respective sizes of the first plurality of cuboids. Examples of how the first and second plurality of cuboids (corresponding to respective first and second bounding boxes) are aligned to the same 3D grid, and how conformance with an alignment condition (e.g., requirement, criterion) may be determined, are described herein, for example, with respect to FIGS. 20-22.

Determining the first plurality of cuboids may comprise decoding occupancy bits of an occupancy tree from a bitstream. The occupancy bits may indicate TriSoup nodes corresponding to the first plurality of cuboids representing the current point cloud. Examples of determining the first plurality of cuboids using an occupancy tree are described herein, for example, with reference to FIG. 3 and FIG. 4. The first bounding box, for example, of a point cloud (e.g., the current point cloud) and/or to code the point cloud (e.g., the current point cloud) may be determined. The first bounding box may be aligned to the 3D grid to which the second bounding box, for example, of the reference point cloud, is aligned. The determination of the first bounding box may be made prior to determining the first plurality of cuboids.

The first bounding box may contain and/or comprise the current point cloud. The second bounding box may contain and/or comprise a reference point cloud. A first origin of the first bounding box may be located at a grid point of the 3D grid and/or an integer coordinate of the 3D grid. Similarly, a second origin of the second bounding box may be located at a second grid point of the 3D grid and/or a second integer coordinate of the 3D grid. The first origin, of the first bounding box, modulo a value of a grid spacing of the 3D grid may be equal to the second origin, of the second bounding box, modulo the value of the grid spacing. The first origin of the first bounding box and the second origin of the second bounding box may be located at the same or different grid point(s) of the 3D grid and/or the same or different integer coordinate(s) of the 3D grid.

The first plurality of cuboids being aligned with the 3D grid may be based on, for example, one or more of the first bounding box axes, of the first bounding box, being substantially parallel to one or more axes of the 3D grid. Also or alternatively, the first plurality of cuboids being aligned with the 3D grid may be based on, for example, a first origin of the first bounding box being located on a first grid point of the 3D grid. The second plurality of cuboids being aligned with the 3D grid may be based on, for example, one or more of the second bounding box axes, of the second bounding box, being substantially parallel to one or more axes of the 3D grid. Also or alternatively, the second plurality of cuboids being aligned with the 3D grid may be based on, for example, a second origin of the second bounding box being located on a second grid point of the 3D grid. The first grid point may be the same as the second grid point. Alternatively, the first grid point may be different from the second grid point.

The first plurality of cuboids being aligned with the 3D grid may be based on, for example, the 3D grid having a grid spacing equal to a maximum size of the first plurality of cuboids. Also or alternatively, the first plurality of cuboids being aligned with the 3D grid may be based on, for example, the 3D grid having a grid spacing equal to a maximum size, of a plurality of respective sizes, of the first plurality of cuboids. Also or alternatively, the first plurality of cuboids being aligned with the 3D grid may be based on, for example, a lowest common multiple of a plurality of respective sizes of the first plurality of cuboids. The second plurality of cuboids being aligned with the 3D grid may be based on, for example, the 3D grid having a grid spacing equal to a maximum size of the second plurality of cuboids. Also or alternatively, the second plurality of cuboids being aligned with the 3D grid may be based on, for example, the 3D grid having a grid spacing equal to a maximum size, of a plurality of respective sizes, of the second plurality of cuboids. Also or alternatively, the second plurality of cuboids being aligned with the 3D grid may be based on, for example, a lowest common multiple of a plurality of respective sizes of the second plurality of cuboids.

An indication of a first origin of the first bounding box aligned with the 3D grid may be coded in (e.g., by an encoder) or from (e.g., by a decoder) a bitstream. The indication may indicate, for example, a displacement of the first origin from a grid origin of the 3D grid. The indication may include and/or indicate three values, for example, along the three axes of the 3D grid, that may each comprise a multiple of a value of a grid spacing of the 3D grid. Also or alternatively, the indication may indicate a displacement of the first origin from a second origin of the second bounding box. The displacement may include and/or indicate three values, for example, along the three axes of the 3D grid, that may each comprise a multiple of a value of a grid spacing of the 3D grid. Conformance and/or non-conformance with an alignment condition (e.g., requirement, criterion) may be determined.

The current point cloud and the reference point cloud may be from a sequence of point clouds (e.g., a GOP), and bounding boxes for point clouds in the sequence may each be aligned to the 3D grid. An origin of each of the bounding boxes aligned with the 3D grid may be coded, for example, based on a previously-coded origin of a bounding box of a previously-coded point cloud in the sequence.

An indication of a displacement of the first bounding box may be coded relative to the second bounding box in the 3D grid. Also or alternatively, an indication may be coded indicating that the first bounding box is equal to a bounding box of a previously-coded point cloud from the sequence of point clouds. The indication of a first origin of the first bounding box may be coded, for example, as being equal to an origin of a bounding box of a previously-coded point cloud from the sequence of point clouds. The bounding box may be the second bounding box.

At step 2304, vertex information of the first plurality of cuboids may be coded. The vertex information may be coded, for example, based on previously-coded vertex information of the second plurality of cuboids. The vertex information may include presence of vertices, for example, on edges of the plurality of cuboids and/or positions of the present vertices, as described herein, for example, with respect to FIG. 8A. The vertex information may include residual values of centroid vertices (e.g., respective centroid vertices) of cuboids (e.g., respective cuboids) of one or more cuboids of the plurality of cuboids, as described herein, for example, with respect to FIG. 8B and FIG. 13. Examples of coding vertex information using OBUF are described herein, for example, with respect to FIGS. 5, 6, 10, and 11. Examples of vertex information of the current point cloud corresponding to a first point cloud frame being inter predicted are described herein, for example, with respect to FIGS. 12, 18, 20, and 21.

TriSoup triangles of the first plurality of cuboids may be determined, for example, based on the vertex information. The TriSoup triangles may be voxelized to determine voxels representing the current point cloud. Examples for voxelization of TriSoup triangles are described herein, for example, with respect to FIG. 9A and FIG. 9B.

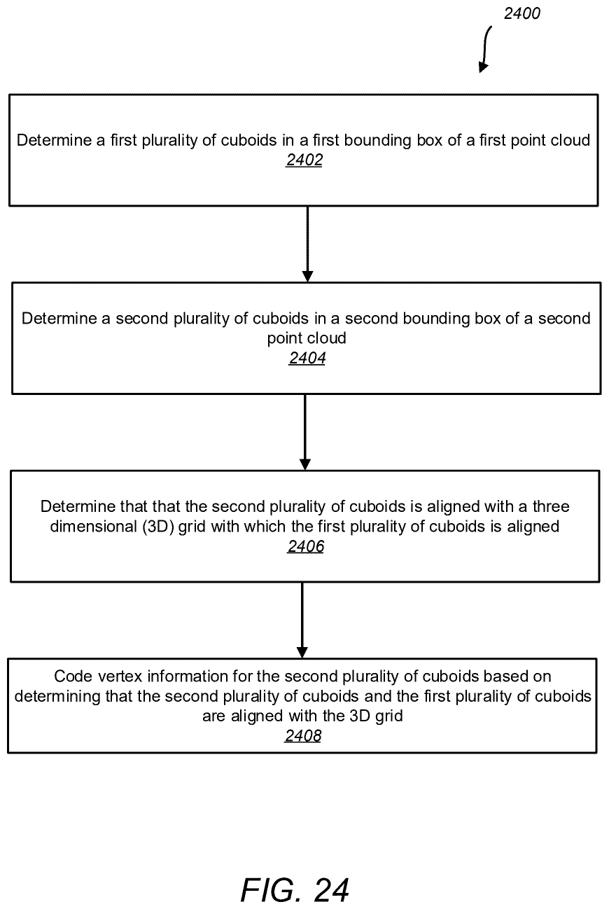

FIG. 24 shows an example method for TriSoup alignment between point clouds. For example, FIG. 24 shows a flowchart 2400 of an example method for TriSoup alignment between point clouds. The method of flowchart 2400 may be performed and/or implemented by a computing device, for example, by an encoder (e.g., encoder 114 in FIG. 1) and/or by a decoder (e.g., decoder 120 in FIG. 1). As described below, the decoder and/or encoder may perform reciprocal operations unless explicitly stated otherwise. Steps (e.g., blocks) of the example method of FIG. 24 may be omitted, performed in other orders, and/or otherwise modified, and/or one or more additional steps may be added.

At step 2404, a first plurality of cuboids may be determined (e.g., coded, decoded). The first plurality of cuboids may be determined, for example, by an encoder and/or by a decoder. The first plurality of cuboids may be in a first bounding box. The first bounding box may be determined. The first plurality of cuboids in the first bounding box may be determined for and/or to code a point cloud. The point cloud may comprise a first point cloud. The first point cloud may comprise a reference point cloud. As described herein, for example, with respect to FIGS. 4, 15A, 15B, 20A, 20B, and 20C the first plurality of cuboids may have the same or different sizes. Determining the first plurality of cuboids may comprise decoding occupancy bits of an occupancy tree from a bitstream. The occupancy bits may indicate TriSoup nodes corresponding to the first plurality of cuboids representing the reference point cloud. Examples of determining the first plurality of cuboids using an occupancy tree are described herein, for example, with reference to FIG. 3 and FIG. 4.

At step 2406, a second plurality of cuboids may be determined (e.g., coded, decoded). The second plurality of cuboids may be determined, for example, by an encoder and/or by a decoder. The second plurality of cuboids may be in a second bounding box. The second bounding box may be determined. The second plurality of cuboids in the second bounding box may be determined for and/or to code a point cloud. The point cloud may comprise a second point cloud. The second point cloud may comprise a current point cloud (e.g., a point cloud associated with a presently/currently coding frame). As described herein, for example, with respect to FIGS. 4, 15A, 15B, 20A, 20B, and 20C the second plurality of cuboids may have the same or different sizes. Determining the second plurality of cuboids may comprise decoding occupancy bits of an occupancy tree from a bitstream. The occupancy bits may indicate TriSoup nodes corresponding to the second plurality of cuboids representing the second point cloud. Examples of determining the second plurality of cuboids using an occupancy tree are described herein, for example, with reference to FIG. 3 and FIG. 4.

At step 2406, a computing device (e.g., encoder 114, decoder 120, etc.) may determine that the first plurality of cuboids is aligned with a 3D grid. Additionally, the computing device may determine that the second plurality of cuboids is aligned with the 3D grid. Further, the computing device may determine that the second plurality of cuboids is aligned with the 3D grid with which the first plurality of cuboids is aligned. The determination may be based on an alignment condition, for example, as described herein. The determination may be based on an active syntax element (e.g., align_slice_flag). The 3D grid may be as substantially described herein, for example, as described with reference to FIGS. 20-23 and elsewhere. Additionally, alignment of the first and/or second cuboids with the 3D grid, and the determination thereof, may also be substantially as described herein, for example, with reference to FIGS. 20-23 and elsewhere.

At step 2408, vertex information for the second plurality of cuboids may be coded. The vertex information may be coded, for example, based on determining that the second plurality of cuboids and the first plurality of cuboids are aligned with the 3D grid. The vertex information for the second plurality of cuboids may be coded, for example, based on previously-coded vertex information of the first plurality of cuboids.

FIG. 25 shows an example computer system in which examples of the present disclosure may be implemented. For example, the example computer system 2500 shown in FIG. 25 may implement one or more of the methods described herein. For example, various devices and/or systems described herein (e.g., in FIGS. 1, 2, and 3) may be implemented in the form of one or more computer systems 1900. Furthermore, each of the steps of the flowcharts depicted in this disclosure may be implemented on one or more computer systems 2500.

The computer system 2500 may comprise one or more processors, such as a processor 2504. The processor 2504 may be a special purpose processor, a general purpose processor, a microprocessor, and/or a digital signal processor. The processor 2504 may be connected to a communication infrastructure 2502 (for example, a bus or network). The computer system 2500 may also comprise a main memory 2506 (e.g., a random access memory (RAM)), and/or a secondary memory 2508.

The secondary memory 2508 may comprise a hard disk drive 2510 and/or a removable storage drive 2512 (e.g., a magnetic tape drive, an optical disk drive, and/or the like). The removable storage drive 2512 may read from and/or write to a removable storage unit 2516. The removable storage unit 2516 may comprise a magnetic tape, optical disk, and/or the like. The removable storage unit 2516 may be read by and/or may be written to the removable storage drive 2512. The removable storage unit 2516 may comprise a computer usable storage medium having stored therein computer software and/or data.

The secondary memory 2508 may comprise other similar means for allowing computer programs or other instructions to be loaded into the computer system 2500. Such means may include a removable storage unit 2518 and/or an interface 2514. Examples of such means may comprise a program cartridge and/or cartridge interface (such as in video game devices), a removable memory chip (such as an erasable programmable read-only memory (EPROM) or a programmable read-only memory (PROM)) and associated socket, a thumb drive and USB port, and/or other removable storage units 2518 and interfaces 2514 which may allow software and/or data to be transferred from the removable storage unit 2518 to the computer system 2500.

The computer system 2500 may also comprise a communications interface 2520. The communications interface 2520 may allow software and data to be transferred between the computer system 2500 and external devices. Examples of the communications interface 2520 may include a modem, a network interface (e.g., an Ethernet card), a communications port, etc. Software and/or data transferred via the communications interface 2520 may be in the form of signals which may be electronic, electromagnetic, optical, and/or other signals capable of being received by the communications interface 2520. The signals may be provided to the communications interface 2520 via a communications path 2522. The communications path 2522 may carry signals and may be implemented using wire or cable, fiber optics, a phone line, a cellular phone link, an RF link, and/or any other communications channel(s).

A computer program medium and/or a computer readable medium may be used to refer to tangible storage media, such as removable storage units 2516 and 2518 or a hard disk installed in the hard disk drive 2510. The computer program products may be means for providing software to the computer system 2500. The computer programs (which may also be called computer control logic) may be stored in the main memory 2506 and/or the secondary memory 2508. The computer programs may be received via the communications interface 2520. Such computer programs, when executed, may enable the computer system 2500 to implement the present disclosure as discussed herein. In particular, the computer programs, when executed, may enable the processor 2504 to implement the processes of the present disclosure, such as any of the methods described herein. Accordingly, such computer programs may represent controllers of the computer system 2500.

Features of the disclosure may be implemented in hardware using, for example, hardware components such as application-specific integrated circuits (ASICs) and gate arrays. Implementation of a hardware state machine to perform the functions described herein will also be apparent to persons skilled in the relevant art(s).

FIG. 26 shows example elements of a computing device that may be used to implement any of the various devices described herein, including, for example, a source device (e.g., 102), an encoder (e.g., 114), a destination device (e.g., 106), a decoder (e.g., 120), and/or any computing device described herein. The computing device 2630 may include one or more processors 2631, which may execute instructions stored in the random-access memory (RAM) 2633, the removable media 2634 (such as a Universal Serial Bus (USB) drive, compact disk (CD) or digital versatile disk (DVD), or floppy disk drive), or any other desired storage medium. Instructions may also be stored in an attached (or internal) hard drive 2635. The computing device 2630 may also include a security processor (not shown), which may execute instructions of one or more computer programs to monitor the processes executing on the processor 2631 and any process that requests access to any hardware and/or software components of the computing device 2630 (e.g., ROM 2632, RAM 2633, the removable media 2634, the hard drive 2635, the device controller 2637, a network interface 2639, a GPS 2641, a Bluetooth interface 2642, a WiFi interface 2643, etc.). The computing device 2630 may include one or more output devices, such as the display 2636 (e.g., a screen, a display device, a monitor, a television, etc.), and may include one or more output device controllers 2637, such as a video processor. There may also be one or more user input devices 2638, such as a remote control, keyboard, mouse, touch screen, microphone, etc. The computing device 2630 may also include one or more network interfaces, such as a network interface 2639, which may be a wired interface, a wireless interface, or a combination of the two. The network interface 2639 may provide an interface for the computing device 2630 to communicate with a network 2640 (e.g., a RAN, or any other network). The network interface 2639 may include a modem (e.g., a cable modem), and the external network 2640 may include communication links, an external network, an in-home network, a provider's wireless, coaxial, fiber, or hybrid fiber/coaxial distribution system (e.g., a DOCSIS network), or any other desired network. Additionally, the computing device 2630 may include a location-detecting device, such as a global positioning system (GPS) microprocessor 2641, which may be configured to receive and process global positioning signals and determine, with possible assistance from an external server and antenna, a geographic position of the computing device 2630.

The example in FIG. 26 may be a hardware configuration, although the components shown may be implemented as software as well. Modifications may be made to add, remove, combine, divide, etc. components of the computing device 2630 as desired. Additionally, the components may be implemented using basic computing devices and components, and the same components (e.g., processor 2631, ROM storage 2632, display 2636, etc.) may be used to implement any of the other computing devices and components described herein. For example, the various components described herein may be implemented using computing devices having components such as a processor executing computer-executable instructions stored on a computer-readable medium, as shown in FIG. 26. Some or all of the entities described herein may be software based, and may co-exist in a common physical platform (e.g., a requesting entity may be a separate software process and program from a dependent entity, both of which may be executed as software on a common computing device).

One or more examples herein may be described as a process which may be depicted as a flowchart, a flow diagram, a data flow diagram, a structure diagram, and/or a block diagram. Although a flowchart may describe operations as a sequential process, one or more of the operations may be performed in parallel or concurrently. The order of the operations shown may be re-arranged. A process may be terminated when its operations are completed, but could have additional steps not shown in a figure. A process may correspond to a method, a function, a procedure, a subroutine, a subprogram, etc. If a process corresponds to a function, its termination may correspond to a return of the function to the calling function or the main function.

Operations described herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks. Features of the disclosure may be implemented in hardware using, for example, hardware components such as application-specific integrated circuits (ASICs) and gate arrays. Implementation of a hardware state machine to perform the functions described herein will also be apparent to persons skilled in the art.

A computing device may perform a method comprising multiple operations. The computing device may determine a first plurality of cuboids in a first bounding box associated with a first point cloud associated with content. The first plurality of cuboids may be aligned with a three-dimensional (3D) grid with which a second plurality of cuboids, in a second bounding box associated with a second point cloud, is aligned. The computing device may code, based on vertex information of the second plurality of cuboids, vertex information of the first plurality of cuboids. The second plurality of cuboids may have been previously-coded. The 3D grid may comprise a grid spacing equal to a maximum size of the first plurality of cuboids. The computing device may further determine the first bounding box, of the first point cloud, that may be aligned to the 3D grid to which the second bounding box of the second point cloud is aligned. The computing device may render, based on the coded vertex information of the first plurality of cuboids, a point cloud frame associated with the content. An origin of the first bounding box may be located at a grid point of the 3D grid. A first origin, of the first bounding box, modulo a value of a grid spacing of the 3D grid may be equal to a second origin, of the second bounding box, modulo the value of the grid spacing. The first bounding box may comprise a current point cloud and the second bounding box may comprise a reference point cloud. The first plurality of cuboids and the second plurality of cuboids being aligned with the 3D grid may comprise: one or more first bounding box axes, of the first bounding box, and one or more second bounding box axes, of the second bounding box, being parallel to one or more axes of the 3D grid; and a first origin of the first bounding box and a second origin of the second bounding box being located on one or more grid points of the 3D grid. The first point cloud may be associated with a video frame. The first point cloud and the second point cloud are from a sequence of point clouds, and wherein bounding boxed for point clouds in the sequence are each aligned to the 3D grid. The vertex information may comprise one or more of: information indicating a presence of vertices on edges of the first plurality of cuboids; positions of the vertices; or residual values of centroid vertices of one or more cuboids of the first plurality of cuboids. The determining the first plurality of cuboids may comprise decoding occupancy bits of an occupancy tree from a bitstream, wherein the occupancy bits may indicate TriSoup nodes corresponding to the first plurality of cuboids representing the first point cloud. The computing device may further determine, based on the vertex information, TriSoup triangles of the first plurality of cuboids. The computing device may further voxelize the TriSoup triangles to determine voxels representing the first point cloud. The computing device may comprise one or more processors; and memory storing instructions that, when executed by the one or more processors, cause the computing device to perform the described method, additional operations and/or include the additional elements. A system may comprise a first computing device configured to perform the described method, additional operations and/or include the additional elements; and a second computing device configured to encode the first point cloud. A computer-readable medium may store instructions that, when executed, cause performance of the described method, additional operations and/or include the additional elements.

A computing device may perform a method comprising multiple operations. The computing device may determine a first plurality of cuboids in a first bounding box of a first point cloud associated with content. The computing device may determine a second plurality of cuboids in a second bounding box associated with a second point cloud associated with the content. The computing device may determine that the second plurality of cuboids is aligned with a three-dimensional (3D) grid with which the first plurality of cuboids is also aligned. Based on determining that the second plurality of cuboids and the first plurality of cuboids are aligned with the 3D grid, the computing device may code vertex information for the second plurality of cuboids. The vertex information may be based on vertex information of the first plurality of cuboids. The vertex information of the first plurality of cuboids may have been previously-coded. The 3D grid may comprise a grid spacing equal to a maximum size of the first plurality of cuboids. The computing device may further determine the first bounding box, of the current point cloud, and the second bounding box of the second point cloud. The computing device may further determine that a first origin of the first bounding box and a second origin of the second bounding box are located at grid points of the 3D grid. The first bounding box may comprise a current point cloud and the second bounding box may comprise a reference point cloud. Determining that the first plurality of cuboids is aligned with the 3D grid may comprise determining that one or more first bounding box axes, of the first bounding box, and one or more second bounding box axes of the second bounding box are substantially parallel to one or more axes of the 3D grid; and determining that a first origin of the first bounding box and a second origin of the second bounding box are located on one or more grid points of the 3D grid. The vertex information may comprise information indicating one or more of: a presence of vertices on edges of the second plurality of cuboids; positions of the vertices; or residual values of centroid vertices of cuboids of one or more of the second plurality of cuboids. The computing device may comprise one or more processors; and memory storing instructions that, when executed by the one or more processors, cause the computing device to perform the described method, additional operations and/or include the additional elements. A system may comprise a first computing device configured to perform the described method, additional operations and/or include the additional elements; and a second computing device configured to encode the first point cloud. A computer-readable medium may store instructions that, when executed, cause performance of the described method, additional operations and/or include the additional elements.

A computing device may perform a method comprising multiple operations. The computing device may decode a first plurality of cuboids in a first bounding box associated with a first point cloud associated with content. The computing device may decode a second plurality of cuboids in a second bounding box associated with a second point cloud associated with the content. The computing device may determine that the second plurality of cuboids is aligned with a three-dimensional (3D) grid with which the first plurality of cuboids is aligned. The computing device may decode, based on vertex information of the first plurality of cuboids, vertex information of the second plurality of cuboids. The vertex information of the first plurality of cuboids may have been previously-coded. The computing device may determine that a first origin of the first bounding box and a second origin of the second bounding box are located at one or more grid points of the 3D grid. The first point cloud may comprise a reference point cloud and the second point cloud may comprise a current point cloud. Determining that the second plurality of cuboids is aligned with the 3D grid with which the first plurality of cuboids is aligned may be based on an active syntax element. The computing device may comprise one or more processors; and memory storing instructions that, when executed by the one or more processors, cause the computing device to perform the described method, additional operations and/or include the additional elements. A system may comprise a first computing device configured to perform the described method, additional operations and/or include the additional elements; and a second computing device configured to encode the first point cloud. A computer-readable medium may store instructions that, when executed, cause performance of the described method, additional operations and/or include the additional elements.

A computing device may perform a method comprising multiple operations. The computing device may determine a first plurality of cuboids in a first bounding box of a first point cloud associated with content. The computing device may determine a second plurality of cuboids in a second bounding box associated with a second point cloud associated with the content. The computing device may determine that the second plurality of cuboids and the first plurality of cuboids are aligned with a three-dimensional (3D) grid. Based on determining that the second plurality of cuboids and first plurality of cuboids are aligned with the 3D grid, the computing device may code vertex information for the first plurality of cuboids. Determining that the second plurality of cuboids and the first plurality of cuboids are aligned with the 3D grid may comprise determining that one or more first bounding box axes, of the first bounding box, and one or more second bounding box axes, of the second bounding box are substantially parallel to one or more axes of the 3D grid; determining that a first origin of the first bounding box and a second origin of the second bounding box are located on one or more grid points of the 3D grid. The coding may further comprise coding vertex information of the first plurality of cuboids based on the second plurality of cuboids. The computing device may comprise one or more processors; and memory storing instructions that, when executed by the one or more processors, cause the computing device to perform the described method, additional operations and/or include the additional elements. A system may comprise a first computing device configured to perform the described method, additional operations and/or include the additional elements; and a second computing device configured to encode the first point cloud. A computer-readable medium may store instructions that, when executed, cause performance of the described method, additional operations and/or include the additional elements.

A computing device may perform a method comprising multiple operations. The computing device may determine a first plurality of cuboids in a first bounding box to code a current point cloud. The first plurality of cuboids may be aligned with a three-dimensional (3D) grid with which a second plurality of cuboids, in a second bounding box of a reference point cloud, may be aligned. The computing device may code vertex information of the first plurality of cuboids based on previously-coded vertex information of the second plurality of cuboids. The 3D grid may be a grid of cuboids. The 3D grid may comprise a grid spacing equal to a maximum size of a plurality of respective sizes of the first plurality of cuboids. The 3D grid may comprise a grid spacing equal to a lowest common multiple of a plurality of respective sizes of the first plurality of cuboids. The computing device may further determine the first bounding box, of the current point cloud, that may be aligned to the 3D grid to which the second bounding box of the reference point cloud is aligned. The first plurality of cuboids may have different sizes. A first origin of the first bounding box may be located at: a grid point of the 3D grid; or an integer coordinate of the 3D grid. A first origin, of the first bounding box, modulo a value of a grid spacing of the 3D grid may be equal to a second origin, of the second bounding box, modulo the value of the grid spacing. The first bounding box may contain the current point cloud and the second bounding box may contain the reference point cloud. The first plurality of cuboids being aligned with the 3D grid may comprise: first bounding box axes, of the first bounding box, being respectively parallel to axes of the 3D grid; and a first origin of the first bounding box being located on a first grid point of the 3D grid. The second first plurality of cuboids being aligned with the 3D grid may comprise: second bounding box axes, of the second bounding box, being respectively parallel to the axes of the 3D grid; and a second origin of the second bounding box being located on a second grid point of the 3D grid. The first grid point may be the same as the second grid point. The first plurality of cuboids being aligned with the 3D grid may further comprise the 3D grid having a grid spacing equal to: a maximum size of a plurality of respective sizes of the first plurality of cuboids; or a lowest common multiple of a plurality of respective sizes of the first plurality of cuboids. The computing device may further code, in or from a bitstream, an indication of a first origin of the first bounding box aligned with the 3D grid. The indication may indicate a displacement of the first origin from a grid origin of the 3D grid. The indication may comprise three values, along the three axes of the 3D grid, that may each be a multiple of a value of a grid spacing of the 3D grid. The indication may indicate a displacement of the first origin from a second origin of the second bounding box. The displacement may comprise three values, along the three axes of the 3D grid, that may each be a multiple of a value of a grid spacing of the 3D grid. The current point cloud and the reference point cloud may be from a sequence of point clouds, and wherein bounding boxes for point clouds in the sequence may each be aligned to the 3D grid. An origin of each of the bounding boxes aligned with the 3D grid may be coded based on a previously-coded origin of a bounding box of a previously-coded point cloud in the sequence. The computing device may further code an indication of a displacement of the first bounding box relative to the second bounding box in the 3D grid. The computing device may further code an indication of the first bounding box being equal to a bounding box of a previously-coded point cloud from the sequence of point clouds. The computing device may further code an indication of a first origin of the first bounding box being equal to an origin of a bounding box of a previously-coded point cloud from the sequence of point clouds. The bounding box may be the second bounding box. The vertex information may comprise presence of vertices on edges of the plurality of cuboids. The vertex information may further comprise respective positions of the present vertices. The vertex information may comprise residual values of respective centroid vertices of respective cuboids of one or more cuboids of the plurality of cuboids. The determining the first plurality of cuboids may comprise: decoding occupancy bits of an occupancy tree from a bitstream. The occupancy bits may indicate TriSoup nodes corresponding to the first plurality of cuboids representing the current point cloud. The computing device may further determine, based on the vertex information, TriSoup triangles of the first plurality of cuboids. The computing device may further voxelize the TriSoup triangles to determine voxels representing the current point cloud. The current point cloud may be associated with content. The reference point cloud may be associated with content. The computing device may comprise one or more processors; and memory storing instructions that, when executed by the one or more processors, cause the computing device to perform the described method, additional operations and/or include the additional elements. A system may comprise a first computing device configured to perform the described method, additional operations and/or include the additional elements; and a second computing device configured to encode the first point cloud. A computer-readable medium may store instructions that, when executed, cause performance of the described method, additional operations and/or include the additional elements.

One or more features described herein may be implemented in a computer-usable data and/or computer-executable instructions, such as in one or more program modules, executed by one or more computers or other devices. Generally, program modules include routines, programs, objects, components, data structures, etc. that perform particular tasks or implement particular abstract data types when executed by a processor in a computer or other data processing device. The computer executable instructions may be stored on one or more computer readable media such as a hard disk, optical disk, removable storage media, solid state memory, RAM, etc. The functionality of the program modules may be combined or distributed as desired. The functionality may be implemented in whole or in part in firmware or hardware equivalents such as integrated circuits, field programmable gate arrays (FPGA), and the like. Particular data structures may be used to more effectively implement one or more features described herein, and such data structures are contemplated within the scope of computer executable instructions and computer-usable data described herein. Computer-readable medium may comprise, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

A non-transitory tangible computer readable media may comprise instructions executable by one or more processors configured to cause operations described herein. An article of manufacture may comprise a non-transitory tangible computer readable machine-accessible medium having instructions encoded thereon for enabling programmable hardware to cause a device (e.g., an encoder, a decoder, a transmitter, a receiver, and the like) to allow operations described herein. The device, or one or more devices such as in a system, may include one or more processors, memory, interfaces, and/or the like.

Communications described herein may be determined, generated, sent, and/or received using any quantity of messages, information elements, fields, parameters, values, indications, information, bits, and/or the like. While one or more examples may be described herein using any of the terms/phrases message, information element, field, parameter, value, indication, information, bit(s), and/or the like, one skilled in the art understands that such communications may be performed using any one or more of these terms, including other such terms. For example, one or more parameters, fields, and/or information elements (IEs), may comprise one or more information objects, values, and/or any other information. An information object may comprise one or more other objects. At least some (or all) parameters, fields, IEs, and/or the like may be used and can be interchangeable depending on the context. If a meaning or definition is given, such meaning or definition controls.

One or more elements in examples described herein may be implemented as modules. A module may be an element that performs a defined function and/or that has a defined interface to other elements. The modules may be implemented in hardware, software in combination with hardware, firmware, wetware (e.g., hardware with a biological element) or a combination thereof, all of which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. Additionally or alternatively, it may be possible to implement modules using physical hardware that incorporates discrete or programmable analog, digital and/or quantum hardware. Examples of programmable hardware may comprise: computers, microcontrollers, microprocessors, application-specific integrated circuits (ASICs); field programmable gate arrays (FPGAs); and/or complex programmable logic devices (CPLDs). Computers, microcontrollers and/or microprocessors may be programmed using languages such as assembly, C, C++ or the like. FPGAs, ASICs and CPLDs are often programmed using hardware description languages (HDL), such as VHSIC hardware description language (VHDL) or Verilog, which may configure connections between internal hardware modules with lesser functionality on a programmable device. The above-mentioned technologies may be used in combination to achieve the result of a functional module.

One or more of the operations described herein may be conditional. For example, one or more operations may be performed if certain criteria are met, such as in computing device, a communication device, an encoder, a decoder, a network, a combination of the above, and/or the like. Example criteria may be based on one or more conditions such as device configurations, traffic load, initial system set up, packet sizes, traffic characteristics, a combination of the above, and/or the like. If the one or more criteria are met, various examples may be used. It may be possible to implement any portion of the examples described herein in any order and based on any condition.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the descriptions herein. Accordingly, the foregoing description is by way of example only, and is not limiting.

1. A method comprising:
determining, by a computing device, a first plurality of cuboids in a first bounding box associated with a first point cloud associated with content, wherein the first plurality of cuboids is aligned with a three-dimensional (3D) grid with which a second plurality of cuboids, in a second bounding box associated with a second point cloud, is aligned; and
coding, based on vertex information of the second plurality of cuboids, vertex information of the first plurality of cuboids.

2. The method of claim 1, wherein the 3D grid comprises a grid spacing equal to a maximum size of the first plurality of cuboids.

3. The method of claim 1, further comprising:
determining the first bounding box, of the first point cloud, that is aligned to the 3D grid to which the second bounding box of the second point cloud is aligned.

4. The method of claim 1, further comprising:
rendering, based on the coded vertex information of the first plurality of cuboids, a point cloud frame associated with the content.

5. The method of claim 1, wherein the first bounding box comprises a current point cloud and the second bounding box comprises a reference point cloud.

6. The method of claim 1, wherein the first plurality of cuboids and the second plurality of cuboids being aligned with the 3D grid comprises:
one or more first bounding box axes, of the first bounding box, and one or more second bounding box axes, of the second bounding box, being parallel to one or more axes of the 3D grid; and
a first origin of the first bounding box and a second origin of the second bounding box being located on one or more grid points of the 3D grid.

7. The method of claim 1, wherein the first point cloud and the second point cloud are from a sequence of point clouds, and wherein bounding boxes for point clouds in the sequence are each aligned to the 3D grid.

8. The method of claim 1, wherein the vertex information comprises one or more of:
information indicating a presence of vertices on edges of the first plurality of cuboids;
positions of the vertices; or
residual values of centroid vertices of one or more cuboids of the first plurality of cuboids.

9. The method of claim 1, wherein the determining the first plurality of cuboids comprises:
decoding occupancy bits of an occupancy tree from a bitstream, wherein the occupancy bits indicate TriSoup nodes corresponding to the first plurality of cuboids representing the first point cloud.

10. The method of claim 1, further comprising:
determining, based on the vertex information, TriSoup triangles of the first plurality of cuboids; and
voxelizing the TriSoup triangles to determine voxels representing the first point cloud.

11. A method comprising:
Determining, by a computing device, a first plurality of cuboids in a first bounding box of a first point cloud associated with content;
determining a second plurality of cuboids in a second bounding box associated with a second point cloud associated with the content;
determining that the second plurality of cuboids is aligned with a three-dimensional (3D) grid with which the first plurality of cuboids is also aligned; and
based on determining that the second plurality of cuboids and the first plurality of cuboids are aligned with the 3D grid, coding vertex information for the second plurality of cuboids.

12. The method of claim 11, wherein the vertex information is based on previously-coded vertex information of the first plurality of cuboids.

13. The method of claim 11, wherein the 3D grid comprises a grid spacing equal to a maximum size of the first plurality of cuboids.

14. The method of claim 11, further comprising:
determining that a first origin of the first bounding box and a second origin of the second bounding box are located at one or more grid points of the 3D grid.

15. The method of claim 11, wherein determining that the first plurality of cuboids is aligned with the 3D grid comprises:
determining that one or more first bounding box axes, of the first bounding box, and one or more second bounding box axes of the second bounding box are parallel to one or more axes of the 3D grid; and
determining that a first origin of the first bounding box and a second origin of the second bounding box are located on one or more grid points of the 3D grid.

16. The method of claim 11, wherein the vertex information comprises information indicating one or more of:
a presence of vertices on edges of the second plurality of cuboids;
position of vertices; or
residual values of centroid vertices of cuboids of one or more of the second plurality of cuboids.

17. A method comprising:
decoding, by a computing device, a first plurality of cuboids in a first bounding box associated with a first point cloud associated with content;
decoding a second plurality of cuboids in a second bounding box associated with a second point cloud associated with the content;
determining that the second plurality of cuboids is aligned with a three-dimensional (3D) grid with which the first plurality of cuboids is aligned; and
decoding, based on vertex information of the first plurality of cuboids, vertex information of the second plurality of cuboids.

18. The method of claim 17, further comprising:
determining that a first origin of the first bounding box and a second origin of the second bounding box are located at one or more grid points of the 3D grid.

19. The method of claim 17, wherein the first point cloud comprises a reference point cloud and wherein the second point cloud comprises a current point cloud.

20. The method of claim 17, wherein determining that the second plurality of cuboids is aligned with the 3D grid with which the first plurality of cuboids is aligned is based on an active syntax element.
